(19) United States
(12) Patent Application Publication
(10) Pub. No.: US 2026/0230633 A1
(43) Pub. Date: Aug. 6, 2026

(54) ENCODING AND DECODING METHODS, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Jiawei FAN, Dongguan (CN); Ming LI, Dongguan (CN)

(21) Appl. No.: 19/636,896

(22) Filed: Apr. 1, 2026

Related U.S. Application Data
(63) Continuation of application No. PCT/CN2023/123103, filed on Oct. 5, 2023.

(51) Int. Cl. H04N 19/159; H04N 19/11; H04N 19/176; H04N 19/593; H04N 19/70

(52) U.S. Cl. CPC H04N 19/159; H04N 19/11; H04N 19/176; H04N 19/593; H04N 19/70

(57) ABSTRACT

A decoding method includes the following. A bitstream is parsed to determine first flag information, where the first flag information indicates that a DIMD Merge mode is used for a current block. Multiple search positions around the current block are determined according to the first flag information, where the multiple search positions include a spatial non-adjacent position of the current block. Gradient information to be blended is determined according to the multiple search positions. A prediction value of the current block is determined according to the gradient information to be blended.

### CROSS-REFERENCE TO RELATED APPLICATION(S)

This application is a continuation of International Application No. PCT/CN2023/123103, filed Oct. 5, 2023, the entire disclosure of which is incorporated herein by reference.

### TECHNICAL FIELD

The present disclosure relates to the field of video coding technology, and in particular to an encoding method, a decoding method, and a storage medium.

### BACKGROUND

Decoder-side intra mode derivation merge (DIMD Merge) mode is an effective intra prediction mode. The DIMD Merge mode utilizes gradient information of an adjacent coding block of a current block to derive a dominant intra prediction mode (or prediction direction), and generates a prediction value accordingly.

However, in the related art, the intra prediction mode derived by the DIMD Merge mode is not accurate enough, which reduces the accuracy of prediction.

### SUMMARY

In a first aspect, a decoding method applied to a decoder is provided. The decoding method includes the following. A bitstream is parsed to determine first flag information. Multiple search positions around a current block are determined according to the first flag information, where the multiple search positions include a spatial non-adjacent position of the current block. Gradient information to be blended is determined according to the multiple search positions. A prediction value of the current block is determined according to the gradient information to be blended.

In a second aspect, an encoding method applied to an encoder is provided. The method includes the following. Multiple search positions around a current block are determined, where the multiple search positions include a spatial non-adjacent position of the current block. Gradient information to be blended is determined according to the multiple search positions. A prediction value of the current block is determined according to the gradient information to be blended.

In a third aspect, a non-transitory computer-readable storage medium storing a bitstream and a computer program is provided. When executed by a processor, the computer program causes the processor to generate the bitstream according to the encoding method in the second aspect.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1 is a schematic structural diagram of a video encoder to which embodiments of the present disclosure can be applied.

FIG. 2 is schematic a structural diagram of a video decoder to which embodiments of the present disclosure can be applied.

FIG. 3 is a schematic flowchart of a prediction process of a DIMD-related mode.

FIG. 4 is an exemplary diagram of a manner for determining a prediction value in a DIMD-related mode.

FIG. 5 is an exemplary diagram of a derivation manner of a gradient histogram of a current block in a DIMD Merge mode.

FIG. 6 is an exemplary diagram of search positions in a DIMD Merge mode.

FIG. 7A is another exemplary diagram of search positions in a DIMD Merge mode.

FIG. 7B is yet another exemplary diagram of search positions in a DIMD Merge mode.

FIG. 8 is a schematic flowchart of a decoding method provided in embodiments of the present disclosure.

FIG. 9 is an exemplary diagram of search positions in a DIMD Merge mode provided in embodiments of the present disclosure.

FIG. 10 is a schematic flowchart of an encoding method provided in embodiments of the present disclosure.

FIG. 11 is a schematic structural diagram of a decoder provided in an embodiment of the present disclosure.

FIG. 12 is a schematic structural diagram of a decoder provided in another embodiment of the present disclosure.

FIG. 13 is a schematic structural diagram of an encoder provided in an embodiment of the present disclosure.

FIG. 14 is a schematic structural diagram of an encoder provided in another embodiment of the present disclosure.

### DETAILED DESCRIPTION

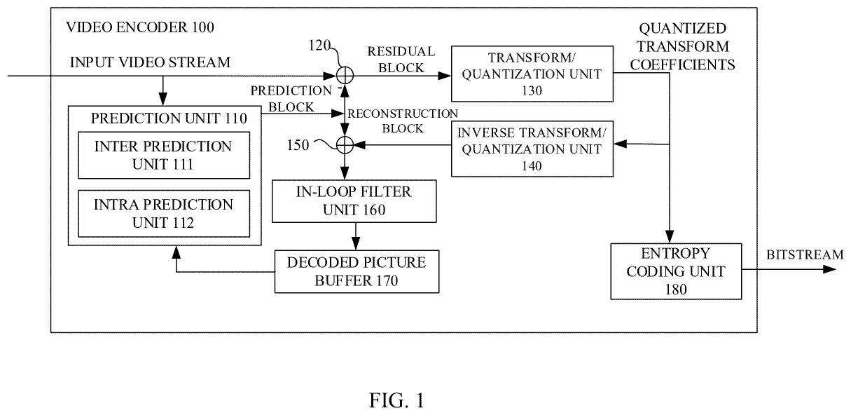

FIG. 1 is a schematic block diagram of a video encoder involved in embodiments of the present disclosure.

It should be understood that the video encoder 100 can be used for performing lossy compression or lossless compression on a picture. The lossless compression can be visually lossless compression or mathematically lossless compression.

The video encoder 100 can be applied to picture data in luminance-chrominance (YCbCr, YUV) format. For example, a YUV ratio can be 4:2:0, 4:2:2, or 4:4:4, where Y represents luminance (luma), Cb (U) represents blue chrominance, Cr (V) represents red chrominance, and U and V are chrominance (chroma) used for describing color and saturation. For example, in terms of color format, 4:2:0 represents each 4 pixels include 4 luma components and 2 chrominance components (YYYYCbCr), 4:2:2 represents each 4 pixels include 4 luma components and 4 chrominance components (YYYYCbCrCbCr), and 4:4:4 represents full-pixel display (YYYYCbCrCbCrCbCrCbCr).

For example, the video encoder 100 reads video data, and for each picture in the video data, the video encoder 100 divides the picture into a number of coding tree units (CTUs). In some examples, a CTU may be referred to as a “tree block”, “largest coding unit (LCU)”, or “coding tree block (CTB)”. Each CTU can be associated with a pixel block of equal size within the picture. Each pixel may correspond to one luminance (or luma) sample and two chrominance (or chroma) samples. Therefore, each CTU can be associated with one luma sample block and two chroma sample blocks. A CTU size can be, for example, 128×128, 64×64, 32×32, etc. A CTU can be further divided into a number of coding units (CUs) for encoding, and a CU can be a rectangular block or a square block. A CU can be further divided into prediction units (PUs) and transform units (TUs), thereby separating encoding, prediction, and transformation for more flexible processing. In one example, a CTU is divided into CUs in a quadtree manner, and a CU is divided into TUs and PUs in a quadtree manner.

Video encoders and video decoders can support various PU sizes. Assuming the size of a specific CU is 2N×2N, a video encoder and a video decoder can support PU sizes of 2N×2N or N×N for intra prediction, and support symmetric PU of sizes such as 2N×2N, 2N×N, N×2N, N×N for inter prediction. The video encoder and the video decoder can also support asymmetric PU of 2N×nU, 2N×nD, nL×2N, and nR×2N for inter prediction.

In some embodiments, as illustrated in FIG. 1, the video encoder 100 may include a prediction unit 110, a residual unit 120, a transform/quantization unit 130, an inverse transform/quantization unit 140, a reconstruction unit 150, an in-loop filter unit 160, a decoded picture buffer 170, and an entropy coding unit 180. It should be noted that the video encoder 100 may include more, fewer, or different functional components.

Optionally, in the present disclosure, a current block may be referred to as a current coding unit (CU) or a current prediction unit (PU), etc. A prediction block may also be referred to as a prediction picture block or a picture prediction block. A reconstructed picture block may also be referred to as a reconstructed block or a picture reconstructed block.

In some embodiments, the prediction unit 110 includes an inter prediction unit 111 and an intra prediction unit 112. Due to the strong correlation between adjacent pixels in one picture of a video, the intra prediction method is used in video coding technology to eliminate spatial redundancy between adjacent pixels. Due to the strong similarity between adjacent pictures in a video, the inter prediction method is used in video coding technology to eliminate temporal redundancy between adjacent pictures, thereby improving coding efficiency.

The inter prediction unit 111 can be used for inter prediction, which may include motion estimation and motion compensation. Picture information of different pictures can be referenced. Inter prediction uses motion information to find a reference block from a reference picture and generates a prediction block based on the reference block, which is used for eliminating temporal redundancy. Inter prediction uses the motion information to find a reference block from a reference picture and generates a prediction block based on the reference block. The motion information includes a reference picture list where the reference picture is in, a reference picture index, and a motion vector. The motion vector can be integer-pixel or fractional-pixel. If the motion vector is fractional-pixel, it is necessary to determine a required fractional-pixel block by using interpolation filtering in the reference picture. The integer-pixel block or fractional-pixel block found in the reference picture according to the motion vector is called a reference block herein. Some technologies directly use the reference block as the prediction block, while other technologies further process the reference block to generate the prediction block. The process of generating the prediction block by further processing the reference block can also be understood as taking the reference block as the prediction block and then processing the prediction block to generate a new prediction block.

The intra prediction unit 112 only references information of the same picture to predict pixel information within the current coding picture block, which is used for eliminating spatial redundancy.

There are multiple prediction modes for intra prediction. For example, for the international digital video coding standard H series, the H.264/AVC standard has 8 angular prediction modes and 1 non-angular prediction mode, and H.265/HEVC expands to 33 angular prediction modes and 2 non-angular prediction modes. The intra prediction modes (IPM) used by HEVC include a planar mode, a DC mode, and 33 angular modes, totaling 35 prediction modes. The intra modes used by VVC include the planar mode, the DC mode, and 65 angular modes, totaling 67 prediction modes.

It should be noted that with the increase of angular modes, intra prediction will be more accurate, which is more in line with the development needs of high-definition and ultra-high-definition digital videos.

The residual unit 120 can generate a residual block of a CU based on a pixel block of the CU and a prediction block of a PU of the CU. For example, the residual unit 120 can generate the residual block of the CU such that each sample in the residual block has a value equal to a difference between a sample in a pixel block of the CU and a corresponding sample in the prediction block of the PU of the CU.

The transform/quantization unit 130 can quantize transform coefficients. The transform/quantization unit 130 can quantize the transform coefficients associated with a TU of the CU based on a quantization parameter (QP) value associated with the CU. The video encoder 100 can adjust the degree of quantization applied to the transform coefficients associated with the CU by adjusting QP value associated with the CU.

The inverse transform/quantization unit 140 can apply inverse quantization and inverse transform to the quantized transform coefficients to reconstruct the residual block from the quantized transform coefficients.

The reconstruction unit 150 can add samples of the reconstructed residual block to the corresponding samples of one or more prediction blocks generated by the prediction unit 110 to generate a reconstructed picture block associated with the TU. By reconstructing the sample block of each TU of the CU in this way, the video encoder 100 can reconstruct the pixel block of the CU.

The in-loop filter unit 160 is used for processing pixels after inverse transform and inverse quantization to compensate for distortion information and provide a better reference for subsequent pixels to be encoded. For example, a deblocking filtering operation can be performed to reduce blocking artifacts of the pixel block associated with the CU.

In some embodiments, the in-loop filter unit 160 includes a deblocking filter unit, a sample adaptive offset (SAO) unit, and an adaptive loop filter (ALF) unit. The deblocking filter unit is used for reducing blocking artifacts, the SAO unit is used for reducing ringing artifacts, and the ALF unit is used for reducing reconstruction errors.

The decoded picture buffer 170 can store reconstructed pixel blocks. The inter prediction unit 111 can use a reference picture containing reconstructed pixel blocks to perform inter prediction on PU of other pictures. In addition, the intra prediction unit 112 can use the reconstructed pixel blocks in the decoded picture buffer 170 to perform intra prediction on other PUs in the same picture to which the CU belongs.

The entropy coding unit 180 can receive quantized transform coefficients from the transform/quantization unit 130. The entropy coding unit 180 can perform one or more entropy coding operations on the quantized transform coefficients to generate entropy-coded data.

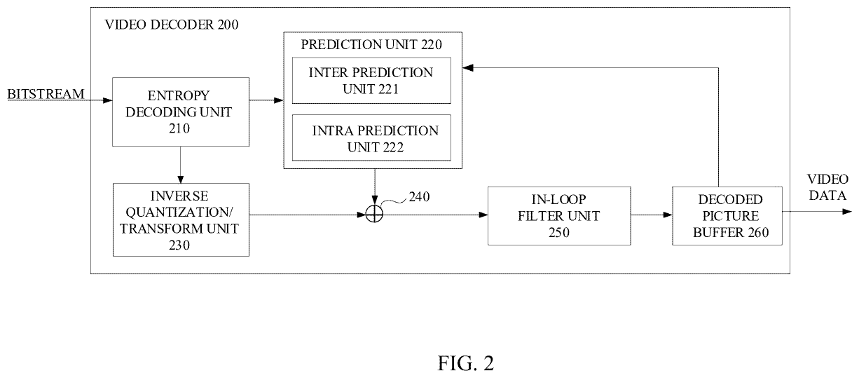

FIG. 2 is a schematic block diagram of a video decoder involved in the embodiments of the present disclosure.

As illustrated in FIG. 2, the video decoder 200 includes an entropy decoding unit 210, a prediction unit 220, an inverse quantization/transform unit 230, a reconstruction unit 240, an in-loop filter unit 250, and a decoded picture buffer 260. It should be noted that the video decoder 200 may include more, fewer, or different functional components.

The video decoder 200 can receive a bitstream. The entropy decoding unit 210 can parse the bitstream to extract a syntax element from the bitstream. As part of parsing the bitstream, the entropy decoding unit 210 can parse an entropy-coded syntax element in the bitstream. The prediction unit 220, the inverse quantization/transform unit 230, the reconstruction unit 240, and the in-loop filter unit 250 can decode the video data according to the syntax element extracted from the bitstream, that is, generate decoded video data.

In some embodiments, the prediction unit 220 includes an intra prediction unit 222 and an inter prediction unit 221.

The intra prediction unit 222 can perform intra prediction to generate a prediction block of a PU. The intra prediction unit 222 can use an intra prediction mode to generate, based on a pixel block of a spatial adjacent PU, the prediction block of the PU. The intra prediction unit 222 can also determine the intra prediction mode of the PU according to one or more syntax elements parsed from the bitstream.

The inter prediction unit 221 can construct a first reference picture list (list 0) and a second reference picture list (list 1) according to the syntax element parsed from the bitstream. In addition, if the PU is encoded using inter prediction, the entropy decoding unit 210 can parse motion information of the PU. The inter prediction unit 221 can determine one or more reference blocks of the PU according to the motion information of the PU. The inter prediction unit 221 can generate the prediction block of the PU according to the one or more reference blocks of the PU.

The inverse quantization/transform unit 230 can inverse quantize (i.e., dequantize) transform coefficients associated with a TU. The inverse quantization/transform unit 230 can determine the degree of quantization using the QP value associated with the CU of the TU.

After inverse quantizing the transform coefficients, the inverse quantization/transform unit 230 can apply one or more inverse transforms to the inverse quantized transform coefficients to generate a residual block associated with the TU.

The reconstruction unit 240 uses the residual block associated with the TU of the CU and the prediction block of the PU of the CU to reconstruct a pixel block of the CU. For example, the reconstruction unit 240 can add a sample of the residual block to a corresponding sample of the prediction block to reconstruct the pixel block of the CU, thus obtaining a reconstructed picture block.

The in-loop filter unit 250 can perform a deblocking filtering operation to reduce blocking artifacts of the pixel block associated with the CU.

The video decoder 200 can store a reconstructed picture of the CU in the decoded picture buffer 260. The video decoder 200 can use the reconstructed picture in the decoded picture buffer 260 as a reference picture for subsequent prediction, or can transmit the reconstructed picture to a display device for presentation.

The basic process of video encoding and decoding is as follows. At the encoding end, a picture is divided into blocks. For a current block, the prediction unit 110 uses intra prediction or inter prediction to generate a prediction block of the current block. The residual unit 120 can calculate a residual block based on the prediction block and an original block of the current block, that is, a difference between the prediction block and the original block of the current block. The residual block can also be referred to as residual information. The residual block is transformed and quantized by the transform/quantization unit 130, which can remove information insensitive to human eyes to eliminate visual redundancy. Optionally, a residual block before transform and quantization by the transform/quantization unit 130 may be referred to as a temporal residual block, and a temporal residual block after transform and quantization by the transform/quantization unit 130 may be referred to as a frequency residual block or a frequency-domain residual block. The entropy coding unit 180 receives quantized transform coefficients output by the transform/quantization unit 130, and can perform entropy coding on the quantized transform coefficients to output a bitstream. For example, the entropy coding unit 180 can eliminate symbol redundancy according to a target context model and probability information of a binary bitstream.

At the decoding end, the entropy decoding unit 210 can parse the bitstream to obtain prediction information, a quantization coefficient matrix, etc., of the current block. The prediction unit 220 uses intra prediction or inter prediction on the current block based on the prediction information to generate the prediction block of the current block. The inverse quantization/transform unit 230 uses the quantization coefficient matrix obtained from the bitstream to perform inverse quantization and inverse transform on the quantization coefficient matrix to obtain the residual block. The reconstruction unit 240 adds the prediction block and the residual block to obtain the reconstructed block. The reconstructed blocks form the reconstructed picture. The in-loop filter unit 250 performs in-loop filtering on the reconstructed picture based on the picture or the block to obtain a decoded picture. The encoding end also needs to perform operations similar to operations at decoding end to obtain the decoded picture. The decoded picture can also be referred to as a reconstructed picture, and the reconstructed picture can be used as the reference picture for inter prediction of subsequent pictures.

It should be noted that the block partitioning information determined by the encoding end, as well as mode information such as prediction, transform, quantization, entropy coding, in-loop filtering, etc. or parameter information is carried in the bitstream when necessary. The decoding end determines the same block partitioning information, mode information such as prediction, transform, quantization, entropy coding, in-loop filtering, etc. or parameter information, as the encoding end by parsing the bitstream and analyzing the existing information, thereby ensuring that the decoded picture obtained by the encoding end is the same as the decoded picture obtained by the decoding end.

The above is the basic process of a video encoder and decoder under a block-based hybrid coding framework. With the development of technology, some modules or steps of the framework or process may be optimized. The present disclosure is applicable to the basic process of a video encoder and decoder under the block-based hybrid coding framework, but is not limited to this framework and process.

The foregoing describes the encoding and decoding framework provided by the embodiments of the present disclosure in detail. Embodiments of the present disclosure mainly relate to a prediction process based on DIMD-related modes, and the prediction process can be implemented in the intra prediction unit in the encoding and decoding framework mentioned above. The following describes the prediction process based on DIMD in detail from the perspective of the decoding end.

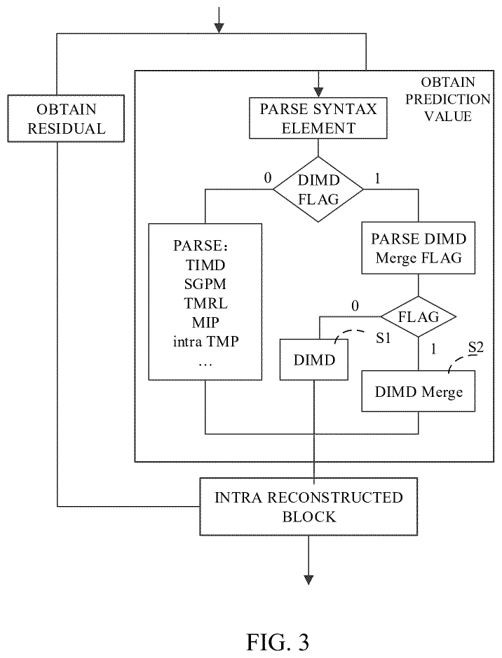

At the decoding end, the basic decoding process for obtaining an intra reconstructed block includes several operations of: obtaining a prediction residual by parsing a bitstream, obtaining a prediction value, and determining a reconstructed value. FIG. 3 illustrates an example of the intra prediction process.

As illustrated in FIG. 3, before determining the reconstructed block of the current block, it is first necessary to obtain the prediction value of the current block. In the process of obtaining the prediction value, a DIMD flag is first parsed. The DIMD flag can indicate whether a DIMD-related mode is used for the current block. Based on the DIMD flag, it can be determined whether the prediction value of the current block is generated through the DIMD-related mode.

If the intra prediction mode of the current block is the DIMD-related mode (for example, a value of the DIMD flag is 1), a DIMD Merge flag can be further parsed to determine whether the prediction value of the current block is generated through the DIMD Merge mode. If the intra prediction mode of the current block is the DIMD Merge mode (for example, a value of the DIMD Merge flag is 1), gradient information of the current block can be derived from gradient information of an adjacent block. If the intra prediction mode of the current block is the DIMD mode (for example, the value of the DIMD Merge flag is 0), the gradient information can be calculated through adjacent samples. After the gradient information is obtained, the prediction mode of the current block can be derived based on the gradient information to generate the prediction value.

If the prediction value of the current block is not generated based on the DIMD-related mode (for example, the value of the DIMD flag is 0), other intra prediction modes can be continued to be parsed to generate the prediction value.

### S1: DIMD Mode

The DIMD mode is a method that utilizes the gradient information of adjacent pixels of the current block to derive a dominant intra prediction mode (or prediction direction), and then obtains the prediction value according to the derived intra prediction mode.

### S1.1 DIMD Intra Mode Derivation

As a possible implementation, a horizontal gradient and a vertical gradient of a adjacent reconstructed pixel can be calculated through a Sobel operator. Formulas of the Sobel operator are as follows, where Gx is used for calculating the horizontal gradient and G_{y} is used for calculating the vertical gradient.

$${G}_{x} = [ \begin{matrix}- 1 & 0 & 1 \\ - 2 & 0 & 2 \\ - 1 & 0 & 1\end{matrix} ] and {G}_{y} = [ \begin{matrix}- 1 & - 2 & - 1 \\ 0 & 0 & 0 \\ 1 & 2 & 1\end{matrix} ]$$

The process of deriving the intra prediction mode by performing gradient analysis on the adjacent pixels using the Sobel operator is described in detail below.

The input of the process is a reconstructed value p[x][y] of the adjacent pixel, where x=0 . . . nTbW−1 and y=0 . . . nTbH−1, where nTbW represents a width of the current block, and nTbH represents a height of the current block.

The output of this process varies in different scenarios. In a scenario of obtaining the DIMD intra prediction value, the output of this process is histogram information. In another application scenario, the output of this process can be a traditional intra prediction mode IntraPredModeD, where IntraPredModeD takes a value between [0,66].

$$Set mapHgV = \{ \{ 2 , 1 \} \} , \{ 1 , 2 \} \} and mapVgH = \{ \{ 3 , 4 \} , \{ 4 , 3 \} \} .$$

$$Set angTable = \{ 0 , 2048 , 4096 , 6144 , 8192 , 12288 , 16384 , 20480 , 24576 , 28672 , 32768 , 36864 , 40960 , 47104 , 53248 , 59392 , 65536 \} .$$

$$Set angOffset = \{ 18 , 18 , 50 , 50 \} .$$

Set HoG[67] as an array containing the gradient intensity of each traditional intra prediction mode. At the start of this process, all values in the histogram of oriented gradient (HoG) array are initialized to 0.

For each reconstructed pixel p[x][y], where x=1 . . . nTbW−2 and y=1 . . . nTbH−2, the calculation process is as follows.
Calculate the horizontal gradient gHor[x][y]=p[x−1][y−1]+2p[x−1][y]+p[x−1][y+1]−p[x+1][y−1]−2p[x+1][y]−p[x+1][y+1];
Calculate the vertical gradient gVer[x][y]=p[x−1][y−1]+2p[x][y−1]+p[x+1][y−1]−p[x−1][y+1]−2p [x][y+1]−p[x+1][y+1];
Calculate iAmp[x][y]=abs(gHor[x][y])+abs(gVer[x][y]);
Calculate signH[x][y]=gHor[x][y]<0?1:0;
Calculate signV[x][y]=gVer[x][y]<0?1:0;
Calculate HgV[x][y]=(abs(gHor[x][y])>abs(gVer[x][y])?1:0);
Calculate region[x][y]=(HgV[x][y]==1? mapHgV[signH[x][y]][sign V[x][y]]:map VgH[signH[x][y]][sign V[x][y]]);
Calculate grad[x][y]=(HgV[x][y]==1? abs(gVer[x][y])/abs(gHor[x][y]):abs (gVer[x][y])/abs(gHor[x][y]));
Calculate grad[x][y]=round (grad[x][y]*(1<<16));
Calculate the index angIdx[x][y]=argminᵢ(abs(angTable[i]−grad[x][y]));
Calculate the intra prediction mode ipm[x][y]=angOffset [region[x][y]]+angIdx[x][y];

$$Set HoG [ ipm [ x ] [ y ] ] = HoG [ ipm [ x ] [ y ] ] + iAmp [ x ] [ y ] ;$$

In the DIMD prediction scenario, all or part information in the gradient histogram will be stored for subsequent operations, and detailed descriptions are referred to S1.2 below.

In another application scenario, a directional mode IntraPredModeD can be further obtained according to the information in the gradient histogram. For example, if the HoG has no non-zero amplitude, IntraPredModeD is set to PLANAR. Otherwise, IntraPredModeD is set to argmaxᵢ(HoG[i]), where i=0, . . . , N, and argmax; (L[i]) returns the index between 0 and N that maximizes L. If there are multiple indexes that maximize L, the index with the smaller value can be returned. Finally, predModeIntra is mapped to IntraPredModeD. It should be understood that this part is not necessary in the scenario of obtaining the prediction value based on DIMD.

### S1.2 Obtain a Prediction Value by DIMD

Before the prediction value is obtained, it is first determined whether to perform weighted blending. If the gradient histogram has not only one direction, weighted blending can be performed. Otherwise, the intra prediction value can be obtained using the only non-zero IPM in the gradient histogram. During implementation, the HoG information can be analyzed. If two highest amplitudes corresponding to two directional modes maxMode[0] (the mode with the highest amplitude in the gradient histogram) and maxMode[1] (the mode with the second highest amplitude in the gradient histogram) are both greater than 0, weighted blending can be performed. Otherwise, weighted blending may not be performed.

If weighted blending is not performed, the IPM with the highest amplitude can be obtained through the gradient histogram information. Then, the prediction value can be directly generated through the prediction mode represented by the IPM.

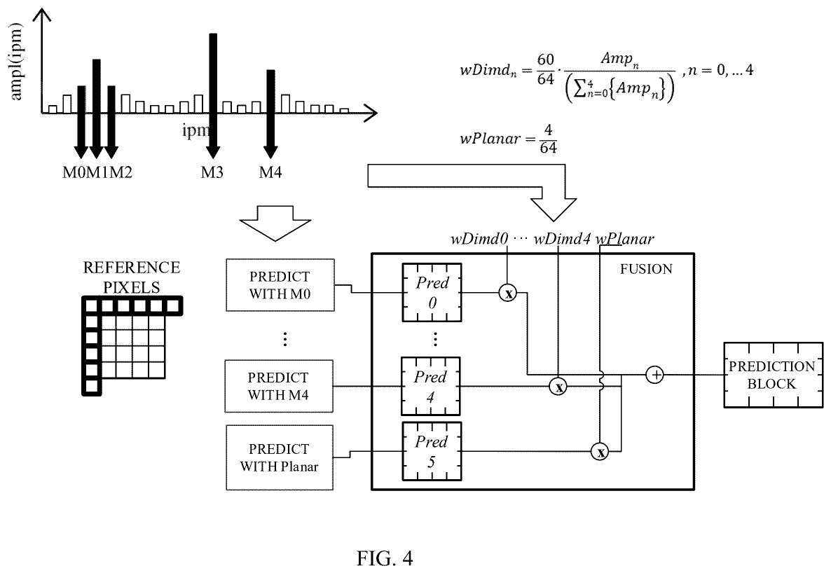

If weighted blending is performed, N (for example, N=5) IPMs with the highest amplitudes, denoted as Mn, n=0 . . . 4, can be obtained through the gradient histogram information, and prediction values corresponding to the modes are denoted as dimdPredₙ, n=0 . . . 4. Then, weighted blending can be performed on the prediction values and a prediction value dimdPlanar of the Planar mode to obtain a final prediction value, and the specific process is illustrated as FIG. 4. A weight wPlanar of the Planar mode can be fixed as 4/64. Then, the remaining 60/64 weight can be allocated to the five IPMs with the highest amplitudes, where the weights wDimdₙ, n=0 . . . 4 of the five IPMs are correlated with the amplitudes of gradient histograms of the five IPMs

The prediction value at (x, y) in the current block can be:

$$fusionPred ( x , y ) = ( {\sum }_{n = 0}^{4} \{ {wDimd}_{n} * {dimdPred}_{n} ( x , y ) \} + wPlanar * dimdPlanar ( x , y ) + 32 ) ≫ 6 ,$$

where dimdPredₙ(x, y) indicates the prediction value generated according to mode Mn at the position (x, y) of the current block, and dimdPlanar (x, y) indicates the prediction value generated according to the Planar mode at the position (x, y) of the current block. The weights wDimdₙ of the five IPMs can be calculated as:

$${wDimd}_{n} = \frac{60}{64} \cdot \frac{{Amp}_{n}}{( {\sum }_{n = 0}^{4} \{ {Amp}_{n} \} )} ,$$

n=0, . . . 4.

### S1.3 Store Gradient Histogram Information

The gradient histogram information of the DIMD mode is stored per coding block. The gradient histogram information can be directly stored, or only the five IPMs with the highest amplitudes in the gradient histogram and the corresponding amplitudes can be stored.

### S2: DIMD Merge Mode

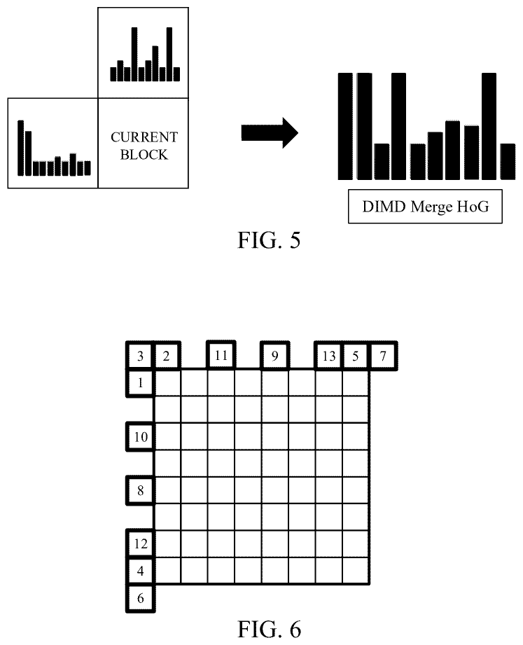

The DIMD Merge mode is a sub-mode of a DIMD-related mode. The DIMD Merge mode is a method that utilizes gradient information of an adjacent coding block of the current block to derive a dominant intra prediction mode (or prediction direction), and generates a prediction value accordingly. FIG. 5 illustrates an example of the derivation process of the gradient information of the current block.

### S2.1 DIMD Merge Intra Mode Derivation

The input of step S2.1 may include the following information:
Top-left corner position (xTL, yTL) of the current block, bottom-left corner position (xLB, yLB) of the current block, and top-right corner position (xRT, yRT) of the current block;
Width uiWidth of the current block and height uiHeigth of the current block;
Adjacent position (xNb[idx], yNb[idx]) of the current block, where idx=1, . . . , 13; and
Corresponding coding block at the adjacent position (xNb[idx], yNb[idx]), denoted as cuNeibor[idx], where idx=1, . . . , 13.

The output of step S2.1 varies in different scenarios. In the scenario of obtaining the DIMD intra prediction value, the output of step S2.1 is histogram information. In another application scenario, the output of step S2.1 may be a traditional intra prediction mode IntraPredModeD. For example, IntraPredModeD takes a value between[0,66].

The process of deriving the traditional intra prediction mode through gradient analysis by DIMD Merge is described in detail below.

### Implementation 1

Step a, adjacent coding blocks, denoted as cuNeibor[idx], corresponding to 13 adjacent positions of the current block are searched, and cuNeibor[idx] are added to a candidate list according to a search order. Whether each cuNeibor[idx] in the candidate list is present, is duplicate, and is in the DIMD or DIMD Merge mode are checked. The adjacent positions of the current block searched in step a are illustrated in Table 1, and the search order for the adjacent positions are illustrated in FIG. 6. If there are duplicate candidate blocks in the candidate list, only one candidate block is retained.

TABLE 1
Candidates in the Candidate List

| idx | (xNb[idx], yNb[idx]) |
|---|---|
| 1 | (xTL − 1, yTL) |
| 2 | (xTL, yTL − 1) |
| 3 | (xTL − 1, yTL − 1) |
| 4 | (xTL − 1, yTL) |
| 5 | (xTL, yTL − 1) |
| 6 | (xLB − 1, yLB + 1) |
| 7 | (xTL + 1, yTL − 1) |
| 8 | (xTL + uiWidth >> 1, yTL − 1) |
| 9 | (xTL − 1, yTL + uiHeigth >> 1) |
| 10 | (xTL + uiWidth >> 2, yTL − 1) |
| 11 | (xTL − 1, yTL + uiHeigth >> 2) |
| 12 | (xTL + 3*(uiWidth >> 2), yTL − 1) |
| 13 | (xTL − 1, yTL + 3*(uiHeigth >> 2)) |

Step b, available candidate blocks in the candidate list are sorted according to the distances between the current block and the available candidate blocks in the candidate list. For example, the top-left corner position of the available candidate block in the candidate list is denoted as (xNeiTL, yNeiTL), then the distance dists[idx] between the current block and the candidate block can be determined using (abs(xTL−xNeiTL)+abs(yTL−yNeiTL)). Then, the available candidate blocks in the candidate list can be sorted in ascending order of the value of dists[idx]. When the values of dists[idx] are equal, the available candidate blocks in the candidate list can be sorted according to the search order.

Step c, the gradient histograms of the top 3 candidate blocks after sorting are read, which are denoted as HoGN[nei], where nei=0 . . . 2. If the number of available candidate blocks is less than 3, HoGN[nei] corresponding to as many available candidate blocks as possible are taken.

Step d, arithmetic averaging is performed on the obtained gradient histograms HoGN[nei] to calculate a gradient histogram HoGM.

Step e, the gradient histogram HoGM is saved per coding block.

Step f, the intra prediction mode of the current block is obtained based on the gradient histogram HoGM.

In the DIMD merge scenario, all or part information of the gradient histogram will be stored for subsequent operations, and detailed descriptions are referred to S2.2 below.

In other application scenarios, a directional mode IntraPredModeD can be further obtained according to the information in the gradient histogram. For example, if the HoG has no non-zero amplitude, set IntraPredModeD to PLANAR. Otherwise, set IntraPredModeD to argmax; (HoG[i]), where i=0, . . . , N, and argmax; (L[i]) returns the index between 0 and N that maximizes L. If there are multiple indexes that maximize L, the index with the smaller value can be returned. Finally, map predModeIntra to IntraPredModeD. It should be understood that this part is not mandatory in the scenario of obtaining the prediction value based on DIMD.

### Implementation 2

Compared with implementation 1, implementation 2 has three obvious differences as follows:
\textcircled{1} In implementation 2, the 13 searched positions are no longer fixed positions, but are adaptively determined based on the block size of the current block and the block size of the candidate block;
\textcircled{2} In implementation 2, the maximum number of available candidate cuNeibor in the candidate list is 5;
\textcircled{3} In implementation 2, for the candidate block, the gradient histogram information HoG of the candidate block is no longer read, but only the 5 IPMs with the highest amplitudes of the candidate blocks and the corresponding amplitudes are read. For the gradient histogram corresponding to the current block, the gradient histogram HoGM corresponding to the current block is no longer saved, but only the 5 IPMs with the highest amplitudes in the gradient histogram and the corresponding amplitudes are saved.

The remaining operations of implementation 2 are consistent with the operations of implementation 1.

The implementation process of implementation 2 is described in more detail below.

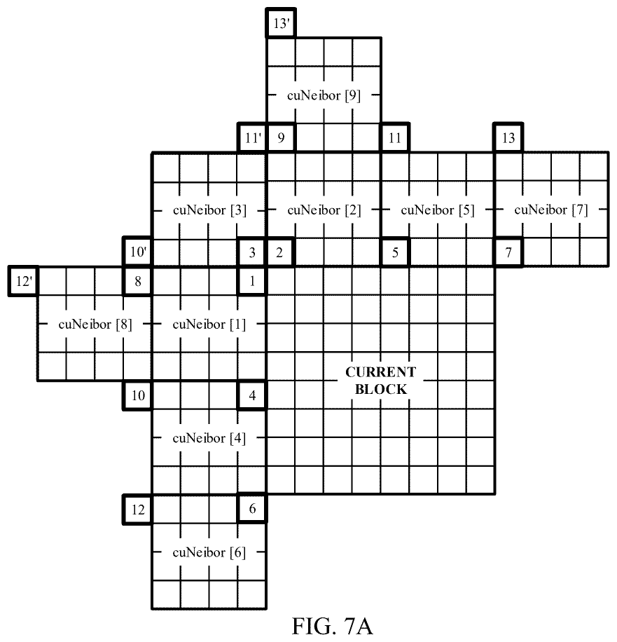

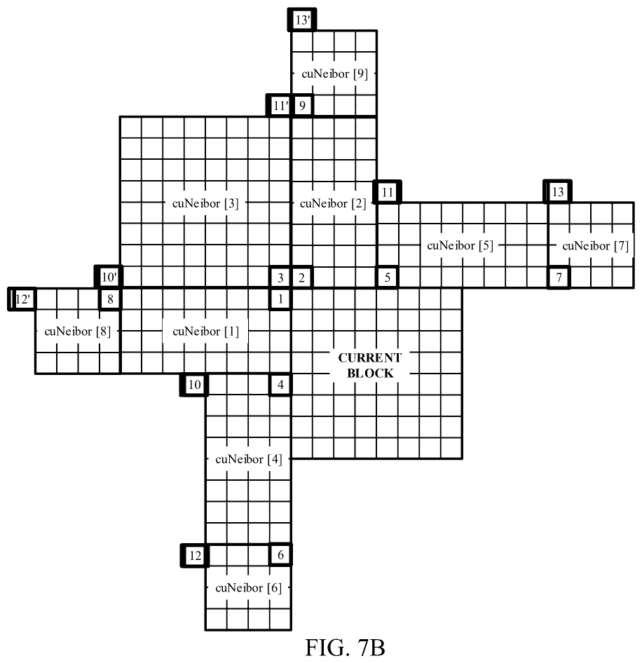

Step a, cuNeibor[idx] corresponding to the 13 adjacent positions of the current block are searched. The adjacent positions searched in implementation 2 are illustrated in Table 2, and examples of the search order for the adjacent positions are illustrated in FIG. 7A and FIG. 7B. The corresponding coding blocks are added to the candidate list in the search order for the 13 adjacent positions, and whether cuNeibor[idx] in the list is present and is in the DIMD or DIMD Merge mode are checked. Due to the change in the search manner, the duplicate check of the candidate block is no longer performed in implementation 2.

TABLE 2
Candidates in the candidate list

| idx | cuNeibor | (xNb[idx], yNb[idx]) |
|---|---|---|
| 1 | cuNeibor | (xTL − 1, yTL) |
| | [1] | |
| 2 | cuNeibor | (xTL, yTL − 1) |
| | [2] | |
| 3 | cuNeibor | (xTL − 1, yTL − 1) |
| | [3] | |
| 4 | cuNeibor | (xNb[1], yNb[1] + cuNeibor [1].height) |
| | [4] | |
| 5 | cuNeibor | (xNb[2] + cuNeibor [2].width, yNb[1]) |
| | [5] | |
| 6 | cuNeibor | (xNb[4], y Nb[4] + cuNeibor [4].height) |
| | [6] | |
| 7 | cuNeibor | (xNb[5] + cuNeibor [5].width, yNb[5]) |
| | [7] | |
| 8 | cuNeibor | (xNb[1] − cuNeibor [1].width, yNb[1]) |
| | [8] | |
| 9 | cuNeibor | (xNb[2], yNb[2] − cuNeibor [2].height) |
| | [9] | |
| 10 | cuNeibor | (xNb[4] − cuNeibor [4].width, yNb[4]) |
| | [10] | |
| 11 | cuNeibor | (xNb[5], yNb[5] − cuNeibor [5].height) |
| | [11] | |
| 12 | cuNeibor | (xNb[6] − cuNeibor [6].width, yNb[6]) |
| | [12] | |
| 13 | cuNeibor | (xNb[7], yNb[7] − cuNeibor [7].height) |
| | [13] | |

During the search process, the position is updated according to the check result of the coding block corresponding to the search position.

Position 1 and position 2: taking position 1/position 2 as a starting point, the height/width of the current block as an ending point, with 4 pixels as the step size, the coding block at the corresponding position is searched for. If the currently found cuNeibor[1] and cuNeibor[2] are present and are in the DIMD mode, the position 1/position 2 is updated to the current position.

Position 10 and position 11: if cuNeighbour[10]/cuNeighbour[11] is not present or is not in the DIMD mode and cuNeighbours[3] is present, the position 10/position 11 is updated to the bottom-left and top-right of cuNeighbours[3], i.e., the position of 10′/11′ in FIG. 7A or FIG. 7B

Position 12 and position 13: if cuNeighbour[12]/cuNeighbour[13] is not present or is not in the DIMD mode, and cuNeighbour[1], cuNeighbour[8]/cuNeighbour[2] and cuNeighbour[9] are present, position 12/position 13 is updated to the left of cuNeighbour[8]/the top of cuNeighbour[9], i.e., the position of 12′/13′ in FIG. 7A or FIG. 7B.

Step b, candidate blocks in the candidate list are sorted according to the distances between the candidate blocks in the candidate list and the current block.

The top-left corner position of the available candidate block in the candidate list is denoted as (xNeiTL, yNeiTL), and then the distance dists[idx] between the current block and the candidate block is (abs(xTL−xNeiTL)+abs(yTL−yNeiTL)). The available candidate blocks in the candidate list can be sorted in ascending order of the value of dists[idx]. When the values of dists[idx] are equal, the available candidate blocks in the candidate list can be sorted according to the search order.

Step c, the 5 IPMs with the highest amplitudes and the corresponding amplitudes of the top 5 available candidate blocks after sorting are read, which are denoted as HoGTemp[nei], where nei=0 . . . 4. If the number of available candidate blocks is less than 5, as many available candidate blocks as possible are taken.

Step d, arithmetic averaging is performed on the obtained gradient histograms HoGTemp[nei] to calculate a gradient histogram HoGMTemp.

Step e, the five IPMs with the highest amplitudes in HoGMTemp and the corresponding amplitudes are saved per the coding block.

Step f, the intra prediction mode of the current block is obtained based on the gradient histogram HoGMTemp.

In the DIMD prediction scenario, all or part information of the gradient histogram will be stored for subsequent operations, and detailed descriptions are taken reference to S2.2 below.

In other application scenarios, a directional mode IntraPredModeD can be further obtained according to the information in the gradient histogram. For example, if the HoG has no non-zero amplitude, set IntraPredModeD to PLANAR. Otherwise, set IntraPredModeD to argmaxᵢ(HoG[i]), where i=0, . . . , N, and argmax; (L[i]) returns the index between 0 and N that maximizes L. If there are multiple indexes that maximize L, the index with the smaller value can be returned. Finally, map predModeIntra to IntraPredModeD. It should be understood that this part is not mandatory in the scenario of obtaining the prediction value based on DIMD.

S2.2 Obtain a prediction value by DIMD Merge

S2.2 is basically consistent with the process of obtaining the prediction value by DIMD illustrated in S1.2. If weighted blending is not performed, the intra prediction mode with the highest amplitude can be obtained through the HoGM information, and the prediction value can be directly generated based on the intra prediction mode. Otherwise, five intra prediction modes with the highest amplitudes can be obtained through the HoGM information, and weighted blending can be performed on the prediction values corresponding to the five intra prediction modes and the prediction value of the Planar mode to obtain the final prediction value. The calculation of weights is consistent with that in S1.2.

The DIMD Merge mode provided by related art only searches 13 predefined or adaptively selected search positions around the current block to determine the candidate blocks. Then, the related art performs availability check, duplicate check, and check of whether the candidate block is in a DIMD-related mode on the candidate blocks at the 13 search positions.

However, after the above checks are performed on the 13 search positions, there is generally a very small number of candidate blocks that pass the checks, which results in inaccurate IPM (or prediction direction) derived through the gradient information of the adjacent block, thereby reducing the accuracy of prediction.

To address the above problem, a decoding method provided in the embodiments of the present disclosure is described in detail with examples below.

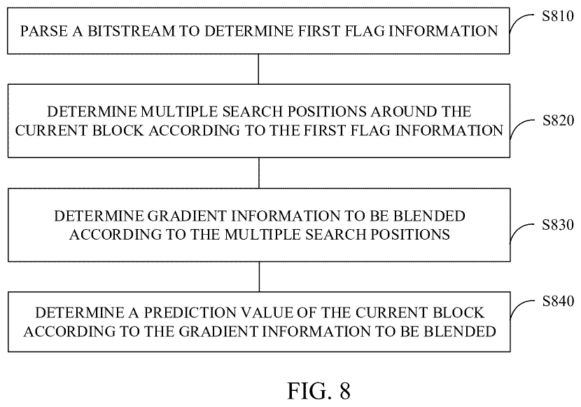

FIG. 8 is a schematic flowchart of a decoding method provided in embodiments of the present disclosure. The method in FIG. 8 may also be referred to as an intra prediction method or a prediction method based on the DIMD Merge mode. The method in FIG. 8 can be applied to a decoder, for example, to a intra prediction unit of the decoder.

With reference to FIG. 8, in step S810, a bitstream is parsed to determine first flag information. The first flag information (such as a DIMD Merge flag) indicates that a DIMD Merge mode is used for a current block.

The current block may also be referred to as a current coding block, a current decoding block, or a current coding unit. For example, the current block can be a luma block.

The first flag information may include, for example, a first value and a second value. The first value may be 1 or true. The first value can indicate that the DIMD Merge mode is used for the current block. The second value may be 0 or false. The second value can indicate that the DIMD Merge mode is not used for the current block. If the DIMD Merge mode is not used for the current block, prediction can be performed on the current block based on the DIMD mode.

In step S820, multiple search positions around the current block are determined according to the first flag information.

In some implementations, the number of multiple search positions around the current block may be greater than 13. For example, the number of search positions around the current block may be greater than or equal to 16, 18, 21, 26, or 31. The number of search positions provided in the embodiments of the present disclosure is greater than the number of search positions provided by the related art (the related art provides 13 search positions). Therefore, the embodiments of the present disclosure search for candidate blocks in a larger search area or in more search positions, thereby helping to improve the accuracy of prediction.

In some implementations, the multiple search positions around the current block (or multiple search positions in the adjacent area of the current block) may include a spatial adjacent position (or an adjacent reference point) and/or a spatial non-adjacent position (or a non-adjacent reference point). For example, searching can be performed at X1 spatial adjacent positions and X2 spatial non-adjacent positions around the current block. A value of X1 may be, for example, less than or equal to 13. A value of X2 may be, for example, 3, 5, 8, 13, or 18. The embodiments of the present disclosure expand the search area, which helps to obtain more available candidate blocks, thereby helping to improve the accuracy of prediction.

In some implementations, the search positions around the current block include the spatial non-adjacent position, and the spatial non-adjacent position is determined based on a predefined position and/or a predefined size. The predefined size may include, for example, a predefined horizontal size (or horizontal step) and/or a predefined vertical size (or vertical step).

In some implementations, the aforementioned predefined position or spatial non-adjacent position may be determined based on one or more of the following:
a position of the current block (such as a top-left corner position of the current block);
a size of the current block (such as a width and/or height of the current block);
a size of an adjacent block of the current block (such as a width and/or height of the adjacent block);
the predefined horizontal size; or
the predefined vertical size.

In some implementations, the aforementioned predefined size (which may include the predefined horizontal size and/or the predefined vertical size) may be determined based on the size of the current block. For example, the predefined horizontal size is determined based on the width of the current block. For another example, the predefined vertical size is determined based on the height of the current block. As a more specific example, the predefined horizontal size is N times the width of the current block, and the predefined vertical size is N times the height of the current block, where Nis a positive integer greater than or equal to 1.

In some implementations, the predefined size mentioned above (which may include the predefined horizontal size and/or the predefined vertical size) may be independent of the size of the current block. For example, both the predefined horizontal size and/or the predefined vertical size may be a fixed value, which may include, for example, one or more of 4, 8, 16, 32, and 64.

For example, the spatial non-adjacent position to be searched around the current block may satisfy at least one of the following:
an absolute value of a horizontal offset between the spatial non-adjacent position and the top-left corner position of the current block is equal to iDistHor+1 (hereinafter referred to as condition 1); or
an absolute value of a vertical offset between the spatial non-adjacent position and the top-left corner position of the current block is equal to iDistVer+1 (hereinafter referred to as condition 2),
where iDistHor is equal to the predefined horizontal size, and iDistVer is equal to the predefined vertical size.

In some implementations, iDistHor may be a fixed value (which may include, for example, one or more of 4, 8, 16, 32, and 64), or may be determined based on the size of the current block (such as the width of the current block). For example, iDistHor may be N times the width of the current block, where Nis a positive integer greater than or equal to 1.

In some implementations, iDistVer may be a fixed value (which may include, for example, one or more of 4, 8, 16, 32, and 64), or may be determined based on the size of the current block (such as the height of the current block). For example, iDistVer may be N times the height of the current block, where Nis a positive integer greater than or equal to 1.

iDistHor and iDistVer can represent the search distance. iDistHor and/or iDistVer is determined based on the size of the current block, which enables the search distance to be adaptively adjusted based on the size of the current block, thus the found gradient information is also more accurate.

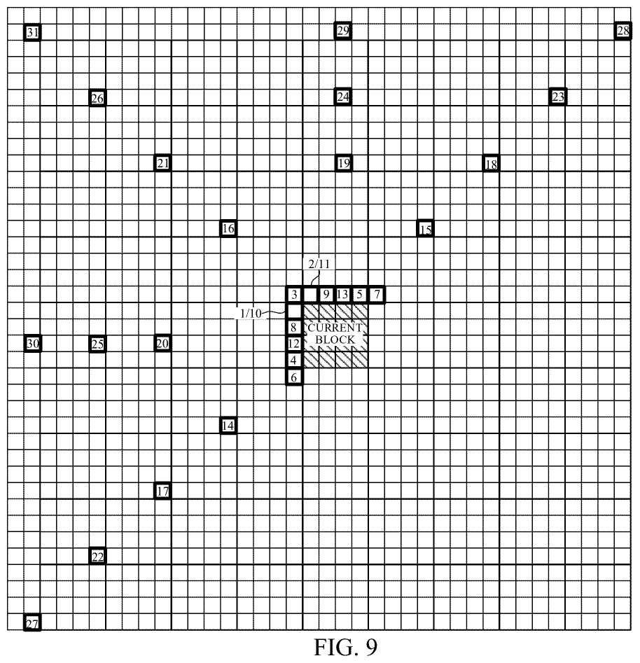

For example, as illustrated in FIG. 9, the spatial non-adjacent positions to be searched around the current block include search positions 14~16. As illustrated in FIG. 9, search position 14 satisfies condition 1, search position 15 satisfies condition 2, and search position 16 satisfies both condition 1 and condition 2. In addition, the value of N corresponding to search position 14~16 is 1, that is, iDistHor is equal to the width of the current block, and iDistVer is equal to the height of the current block. In other words, the spatial non-adjacent positions 14~16 can be obtained by searching the search area defined by a one-time step, with the position of the current block as the starting position and the one-time step of the current block as the search step.

For example, as illustrated in FIG. 9, the spatial non-adjacent positions of the current block include search positions 17~21. As illustrated in FIG. 9, search position 17 satisfies condition 1, search position 18 satisfies Condition 2, search position 19 satisfies condition 2, search position 20 satisfies condition 1, and search position 21 satisfies both condition 1 and condition 2. In addition, the value of N corresponding to search positions 17~21 is 2, that is, iDistHor is equal to two times the width of the current block, and iDistVer is equal to two times the height of the current block. In other words, the spatial non-adjacent positions 17~21 can be obtained by searching the search area defined by a two-time step, with the position of the current block as the starting position and the two-time step of the current block as the search step.

For example, as illustrated in FIG. 9, the spatial non-adjacent positions of the current block include search positions 22~26. As illustrated in FIG. 9, search position 22 satisfies condition 1, search position 23 satisfies condition 2, search position 24 satisfies condition 2, search position 25 satisfies condition 1, and search position 26 satisfies both condition 1 and condition 2. In addition, the value of N corresponding to search positions 22~26 is 3, that is, iDistHor is equal to three times the width of the current block, and iDistVer is equal to three times the height of the current block. In other words, the spatial non-adjacent positions 22~26 can be obtained by searching the search area defined by a three-time step, with the position of the current block as the starting position and the three-time step of the current block as the search step.

For example, as illustrated in FIG. 9, the spatial non-adjacent positions of the current block include search positions 27~31. As illustrated in FIG. 9, search position 27 satisfies condition 1, search position 28 satisfies condition 2, search position 29 satisfies condition 2, search position 30 satisfies condition 1, and search position 31 satisfies both condition 1 and condition 2. In addition, the value of N corresponding to search positions 27~31 is 4, that is, iDistHor is equal to four times the width of the current block, and iDistVer is equal to four times the height of the current block. In other words, the spatial non-adjacent positions 27~31 can be obtained by searching the search area defined by a four-time step, with the position of the current block as the starting position and the four-time step of the current block as the search step.

As mentioned above, iDistHor is equal to N times the width of the current block, and iDist Ver is equal to N times the height of the current block. Alternatively, iDistHor is equal to N times the width of the left adjacent block of the current block, and iDistVer is equal to N times the height of the upper adjacent block of the current block.

In some implementations, the value of N mentioned above may be less than or equal to 4. For example, the value of N includes 1, 2, 3, and 4. Alternatively, the value of N may also be greater than 4, such as 5, 6, or 7. The value of Nis set to be less than or equal to 4, which can minimize the implementation complexity of the search process on the premise of obtaining sufficient gradient information.

In some implementations, the spatial non-adjacent position to be searched around the current block satisfies: xNb=xTL+offsetX, and yNb=yTL+offset, where the offsetX and the offsetY satisfy at least one of the following:

$$offsetX = uiWidth + iDistHor - 1 , and offsetY = - iDistVer - 1 ;$$

$$offsetX = uiWidth ≫ 1 , and offsetY = - iDistVer - 1 ;$$

$$offsetX = - iDistHor - 1 , and offsetY = - iDistVer - 1 ;$$

$$offsetX = - iDistHor - 1 , and offsetY = uiHeight ≫ 1 ; or$$

$$offsetX = - iDistHor - 1 , and offsetY = uiHeight + iDistVer - 1 ,$$

where xNb represents a horizontal coordinate of the spatial non-adjacent position, yNb represents a vertical coordinate of the spatial non-adjacent position, xTL represents a horizontal coordinate of the top-left corner position of the current block, yTL represents a vertical coordinate of the top-left corner position of the current block, uiWidth represents the width of the current block, and uiHeigth represents the height of the current block.

The above-mentioned spatial non-adjacent positions provided in the embodiments of the present disclosure are uniformly distributed around the current block, so that as much available gradient information as possible can be found with as few search positions as possible.

For example, as illustrated in FIG. 9, assume that N=1, then iDistHor is equal to the width of the current block, and iDistVer is equal to the height of the current block. Furthermore, if offsetX=uiWidth+iDistHor−1 and offsetY=−iDistVer−1, the spatial non-adjacent position (xNb, yNB) refers to search position 15 in FIG. 9. If offsetX=uiWidth>>1 and offsetY=−iDistVer−1, the spatial non-adjacent position (xNb, yNB) is above the current block and has the same horizontal position as search position 15 (this search position is not numbered in FIG. 9). If offsetX=−iDistHor−1 and offsetY=−iDistVer−1, the spatial non-adjacent position (xNb, yNB) refers to search position 16 in FIG. 9. If offsetX=−iDistHor−1 and offsetY=uiHeigth>>1, the spatial non-adjacent position (xNb, yNB) is directly left of the current block and has the same vertical position as search position 16 (this search position is not numbered in FIG. 9). If offsetX=−iDistHor−1 and offsetY=uiHeigth+iDistVer−1, the spatial non-adjacent position (xNb, yNB) refers to search position 14 in FIG. 9. Furthermore, in some implementations, when N=1, the offsetX and the offsetY satisfy at least one of the following: offsetX=uiWidth+iDistHor−1 and offsetY=−iDistVer−1; offsetX=−iDistHor−1 and offsetY=−iDistVer−1; or offsetX=−iDistHor−1 and offsetY=uiHeigth+iDistVer−1. For example, as illustrated in FIG. 9, when N=1, the spatial non-adjacent position (xNb, yNB) may include the positions of search positions 14~16 in FIG. 9.

For example, as illustrated in FIG. 9, assume that N=2, then iDistHor is equal to two times the width of the current block, and iDistVer is equal to two times the height of the current block. Furthermore, if offsetX=uiWidth+iDistHor−1 and offsetY=−iDistVer−1, the spatial non-adjacent position (xNb, yNB) refers to search position 18 in FIG. 9. If offsetX=uiWidth>>1 and offsetY=-iDist Ver-1, the spatial non-adjacent position (xNb, yNB) refers to search position 19 in FIG. 9. If offsetX=−iDistHor−1 and offsetY=−iDistVer−1, the spatial non-adjacent position (xNb, yNB) refers to search position 21 in FIG. 9. If offsetX=−iDistHor−1 and offsetY=uiHeigth>>1, the spatial non-adjacent position (xNb, yNB) refers to search position 20 in FIG. 9. If offsetX=−iDistHor−1 and offsetY=uiHeigth+iDistVer−1, the spatial non-adjacent position (xNb, yNB) refers to search position 17 in FIG. 9.

For example, as illustrated in FIG. 9, assume that N=3, then iDistHor is equal to three times the width of the current block, and iDistVer is equal to three times the height of the current block. Furthermore, if offsetX=uiWidth+iDistHor−1 and offsetY=-iDist Ver-1, the spatial non-adjacent position (xNb, yNB) refers to search position 23 in FIG. 9. If offsetX=uiWidth>>1 and offsetY=−iDistVer−1, the spatial non-adjacent position (xNb, yNB) refers to search position 24 in FIG. 9. If offsetX=−iDistHor−1 and offsetY=−iDistVer−1, the spatial non-adjacent position (xNb, yNB) refers to search position 26 in FIG. 9. If offsetX=−iDistHor−1 and offsetY=uiHeigth>>1, the spatial non-adjacent position (xNb, yNB) refers to search position 25 in FIG. 9. If offsetX=−iDistHor−1 and offsetY=uiHeigth+iDistVer−1, the spatial non-adjacent position (xNb, yNB) refers to search position 22 in FIG. 9.

For example, as illustrated in FIG. 9, assume that N=4, then iDistHor is equal to four times the width of the current block, and iDistVer is equal to four times the height of the current block. Furthermore, if offsetX=uiWidth+iDistHor−1 and offsetY=-iDist Ver-1, the spatial non-adjacent position (xNb, yNB) refers to search position 28 in FIG. 9. If offsetX=uiWidth>>1 and offsetY=−iDistVer−1, the spatial non-adjacent position (xNb, yNB) refers to search position 29 in FIG. 9. If offsetX=−iDistHor−1 and offsetY=−iDistVer−1, the spatial non-adjacent position (xNb, yNB) refers to search position 31 in FIG. 9. If offsetX=−iDistHor−1 and offsetY=uiHeigth>>1, the spatial non-adjacent position (xNb, yNB) refers to search position 30 in FIG. 9. If offsetX=−iDistHor−1 and offsetY=uiHeigth+iDistVer−1, the spatial non-adjacent position (xNb, yNB) refers to search position 27 in FIG. 9.

In some implementations, the spatial non-adjacent position around the current block satisfies at least one of the following: being at the top-right of the current block, being above the current block, being at the top-left of the current block, being to the left of the current block, or being at the bottom-left of the current block. If the direction of the horizontal coordinate is taken as the reference, the spatial non-adjacent position around the current block satisfies at least one of the following: being at the 45° direction of the current block, being at the 90° direction of the current block, being at the 135° direction of the current block, being at the 180° direction of the current block, or being at the 225° direction of the current block. The above directions can be understood as the search directions for the spatial non-adjacent positions around the current block. In other words, searching can be performed along the above directions with the position of the current block as the reference to determine the spatial non-adjacent positions of the current block. The search step in each search direction can be determined based on N (or iDistHor and iDistVer) mentioned above. The above-mentioned spatial non-adjacent positions provided in the embodiments of the present disclosure are uniformly distributed around the current block, so that as much available gradient information as possible can be found with as few search positions as possible.

In some implementations, the number of search positions and/or the size of the search range can be adaptively adjusted. For example, the number of search positions and/or the size of the search range can be determined based on the size of the current block. The number of search positions and/or the size of the search range is adaptively adjusted according to the size of the current block, which can make the found gradient information more accurate.

As an example, the value range of N (or iDistHor and iDistVer) mentioned above can be determined according to the size of the current block. For example, if the size of the current block is a first size, the value range of Nis a first value range. If the size of the current block is a second size, the value range of Nis a second value range. Furthermore, in some implementations, if the first size is smaller than the second size, the first value range is narrower than the second value range. In other words, if the current block is a small block, the search range of the spatial non-adjacent positions of the current block is reduced. If the current block is a large block, the search range of the spatial non-adjacent positions of the current block is expanded. In this way, the prediction process are more flexible. For example, if the size of the current block is the first size, the value range of Nis 1~3. If the size of the current block is the second size (larger than the first size), the value range of Nis 1~4.

As another example, if the size of the current block is smaller than a preset size (such as 16×16), the spatial adjacent position of the current block may not include at least one of the following positions:
a first position, corresponding to the 1/4 position of the height of the current block (with reference to search position 10 in FIG. 6);
a second position, corresponding to the 1/4 position of the width of the current block (with reference to search position 11 in FIG. 6);
a third position, corresponding to the 3/4 position of the height of the current block (with reference to search position 12 in FIG. 6);
a fourth position, corresponding to the 3/4 position of the width of the current block (with reference to search position 13 in FIG. 6);
a fifth position, corresponding to the 1/2 position of the height of the current block (with reference to search position 8 in FIG. 6); or
a sixth position, corresponding to the 1/2 position of the width of the current block (with reference to search position 9 in FIG. 6).

As yet another example, the above two examples can be combined together. For example, if the size of the current block is smaller than a preset size (such as 16×16), the value range of N can be limited to the second value range (such as 1~3), thereby reducing the number of spatial non-adjacent positions to be searched. Furthermore, one or more positions among the above-mentioned first to sixth position can be removed (such as the first to the fourth position are removed at the same time), thereby reducing the number of spatial adjacent positions to be searched.

In step S830, gradient information to be blended is determined according to multiple search positions around the current block.

In some implementations, step S830 may include the following. A candidate-block set (such as a candidate list) is determined according to multiple search positions around the current block. The gradient information to be blended is determined according to the candidate-block set. The candidate-block set may be determined according to multiple search positions around the current block as follows. The candidate blocks corresponding to the multiple search positions are added to the candidate-block set. The gradient information to be blended may be determined according to the candidate-block set as follows. The candidate blocks in the candidate-block set are sorted, and the gradient information corresponding to one or more candidate blocks ranked highest is used as the gradient information to be blended.

The form or content of gradient information is not specifically limited by the embodiments of the present disclosure. For example, in some implementations, the gradient information may be gradient histogram information (HoG information). The gradient histogram information may also be referred to or replaced with angular mode HoG information. In other implementations, the gradient information may include a set of IPMs and corresponding amplitudes of the set of IPMs. The set of IPMs may be, for example, a set of IPMs with the highest amplitudes in the gradient histogram. The set of IPMs may include 3 IPMs, 5 IPMs, or other numbers of IPMs.

In some implementations, the gradient information to be blended may be gradient information corresponding to K candidate blocks, where K is a positive integer greater than 3. For example, the value of K may be 5. Another example is that the value of K may be greater than 5, such as 6, 7, or 8. The K candidate blocks mentioned herein may be determined based on multiple search positions around the current block. For example, the candidate-block set (such as the candidate list, which can be used for storing a coding block corresponding to the search position) may be determined according to multiple search positions around the current block, and the K candidate blocks may be determined from the candidate-block set. The manner of determining K candidate blocks from the candidate-block set may include the following. For example, the candidate blocks in the candidate-block set are sorted (such as according to the distance between the top-left corner position of the candidate block and the top-left corner position of the current block), and then the gradient information corresponding to the top K candidate blocks after sorting is determined as the gradient information to be blended. Furthermore, in some implementations, if the number of available candidate blocks in the candidate-block set is less than K, the gradient information to be blended may be the gradient information corresponding to all available candidate blocks in the candidate-block set. By increasing the number of candidate blocks used for providing gradient information (in related art, K=3), the accuracy of the blended gradient information can be improved, thereby improving the accuracy of prediction.

In some implementations, the gradient information to be blended is K gradient histograms, where K is a positive integer greater than 3. For example, the value of K may be 5, or the value of K may be greater than 5, such as 6, 7, or 8.

In some implementations, the gradient information to be blended is amplitudes corresponding to K sets of IPMs, where K is a positive integer greater than 3. For example, the value of K may be 5, or the value of K may be greater than 5, such as 6, 7, or 8. Each set of IPMs may include 3, 5, or more IPMs.

In some implementations, the gradient information to be blended is determined based on the candidate-block set. The candidate-block set may be determined based on multiple search positions around the current block. The candidate-block set may include duplicate candidate blocks or no duplicate candidate blocks. For example, the candidate-block set (such as the candidate list, which can be used for storing the coding block corresponding to the search position) may be determined according to multiple search positions around the current block. A duplicate check may be performed on the candidate blocks in the candidate-block set. If the candidate-block set includes duplicate candidate blocks, only one candidate block of the duplicate blocks is retained. The duplicate check is introduced, which can avoid redundant gradient information, thereby improving the accuracy of prediction.

In some implementations, the gradient information to be blended is gradient information corresponding to at least one candidate block in the candidate-block set. The candidate-block set may be determined based on multiple search positions around the current block. The candidate-block set may include M candidate blocks (where Mis a positive integer greater than or equal to 1), and the order of the M candidate blocks in the candidate-block set is determined based on the distances between the M candidate blocks and the current block. The M candidate blocks are sorted according to the distances between the candidate blocks and the current block, which can help to preferentially find gradient information corresponding to a nearer search position.

The distances between the M candidate blocks and the current block may be defined in different manners. For example, the distances between the top-left corner positions of the M candidate blocks and the top-left corner position of the current block may be used as the distances between the M candidate blocks and the current block. Another example is that the distances between the center positions of the M candidate blocks and the center position of the current block may be used as the distances between the M candidate blocks and the current block.

As an example, the M candidate blocks include a first candidate block (which may be any candidate block among the M candidate blocks). The distance between the first candidate block and the current block is determined based on a difference between a first distance and a second distance. The first distance represents a horizontal distance between the top-left corner position of the first candidate block and the top-left corner position of the current block, and the second distance represents a vertical distance between the top-left corner position of the first candidate block and the top-left corner position of the current block. For example, the distance between the first candidate block and the current block satisfies: (abs(xTL−xNeiTL)+abs(yTL−yNeiTL)+abs(abs(xTL−xNeiTL)−abs(yTL−yNeiTL))), where xTL represents the horizontal coordinate of the top-left corner position of the current block, yTL represents the vertical coordinate of the top-left corner position of the current block, xNeiTL represents the horizontal coordinate of the top-left corner position of the first candidate block, yNeiTL represents the vertical coordinate of the top-left corner position of the first candidate block, and abs represents an absolute value operation. The distance determined by the above distance determination manner is close to the Euclidean distance between the two positions, thus the distance is also more accurate. In a specific implementation process, deltaX=abs(xTL−xNeiTL) and deltaY=abs(yTL−yNeiTL) may be calculated first, and then (deltaX+deltaY+abs(deltaX−deltaY)) is calculated, thereby avoiding unnecessary redundant calculations.

As another example, the M candidate blocks include a second candidate block (which may be any candidate block among the M candidate blocks). The distance between the second candidate block and the current block satisfies: (abs(xTL−xNeiTL)+abs(yTL−yNeiTL)), where xTL represents the horizontal coordinate of the top-left corner position of the current block, yTL represents the vertical coordinate of the top-left corner position of the current block, xNeiTL represents the horizontal coordinate of the top-left corner position of the second candidate block, yNeiTL represents the vertical coordinate of the top-left corner position of the second candidate block, and abs represents the absolute value operation. The above distance determination manner is compatible with the distance determination manner provided by related art.

In some implementations, if two candidate blocks among the M candidate blocks have a same distance to the current block, for the two candidate blocks, the order of the candidate block to the left of the current block is higher than the order of the candidate block above the current block. For example, for the two candidate blocks, the priority of the candidate block to the left of the current block is higher than the priority of the candidate block above the current block. Alternatively, for the two candidate blocks, the value of the index of the candidate block to the left of the current block is smaller than the value of the index of the candidate block above the current block.

In some implementations, if two candidate blocks among the M candidate blocks have a same distance to the current block, for the two candidate blocks, the order of the candidate block above the current block is higher than the order of the candidate block to the left of the current block. For example, for the two candidate blocks, the priority of the candidate block above the current block is higher than the priority of the candidate block to the left of the current block. Alternatively, for the two candidate blocks, the value of the index of the candidate block above the current block is smaller than the value of the index of the candidate block to the left of the current block.

In step S840, a prediction value of the current block is determined according to the gradient information to be blended.

In some implementations, step S840 may include the following. Target gradient information is determined according to the gradient information to be blended. The prediction value of the current block is determined according to the target gradient information. The target gradient information may be, for example, the gradient information corresponding to the current block.

In some implementations, the target gradient information may be determined according to the gradient information to be blended as follows. Arithmetic averaging is performed on the gradient information to be blended to determine the target gradient information.

In some implementations, the prediction value of the current block may be determined according to the target gradient information as follows. One or more IPMs are determined according to the target gradient information. Intra prediction is performed on the current block according to the one or more IPMs to determine one or more prediction values. The prediction value of the current block is determined according to the one or more prediction values. For detailed descriptions, reference may be taken to S1.2 above.

In some implementations, the gradient information to be blended may be gradient information corresponding to at least one candidate block. The at least one candidate block may be determined from the candidate-block set, and the candidate-block set may be determined based on multiple search positions around the current block. Furthermore, in some implementations, normalization may be performed on the gradient information corresponding to the at least one candidate block according to the size (or block size) of the at least one candidate block to determine the gradient information to be blended. For example, at least one gradient histogram which corresponds one-to-one to the at least one candidate block may be determined first, and then the amplitude (or intensity) corresponding to each IPM in the at least one gradient histogram may be normalized according to the size of the at least one candidate block, and the normalized gradient histogram is used as the gradient information to be blended. Normalization is performed on the gradient information corresponding to the candidate block according to the size of the candidate block, which can help to improve the accuracy of gradient information blending.

In some implementations, arithmetic averaging or weighted averaging may be performed on the gradient information to be blended to determine target gradient information. The prediction value of the current block is determined according to the target gradient information. For example, for the gradient information to be blended included one or more gradient histograms, the one or more gradient histograms may be weighted to obtain the gradient histogram corresponding to the current block (i.e., target gradient information). The prediction value of the current block may be determined according to the gradient histogram corresponding to the current block. The weighted averaging is performed on different gradient information to be blended, which can help to improve the accuracy of gradient information blending.

The manner of determining the weight of the gradient information to be blended is not specifically limited in the embodiments of the present disclosure. For example, as mentioned above, the gradient information to be blended may be gradient information corresponding to at least one candidate block in the candidate-block set. Therefore, in some implementations, the weight of the gradient information to be blended may be determined according to the at least one candidate block.

As an example, the weight of the gradient information to be blended may be determined according to the distance between the at least one candidate block and the current block. For example, a higher weight may be set for the gradient information corresponding to the candidate block that is closer to the current block among the at least one candidate block, and a lower weight may be set for the gradient information corresponding to the candidate block that is farther from the current block among the at least one candidate block.

As another example, the weight of the gradient information to be blended may be determined according to the size of the at least one candidate block. For example, a higher weight may be allocated to the block with a larger size among the at least one candidate block, and a lower weight may be allocated to the block with a smaller size.

As yet another example, the weight of the gradient information to be blended may be determined according to the number of target pixels corresponding to the at least one candidate block. The target pixels are pixels required for determining gradient information in the DIMD mode. The target pixels corresponding to the at least one candidate block may be determined based on the size and/or position of the at least one candidate block. For example, a higher weight may be allocated to the block with more corresponding target pixels among the at least one candidate block, and a lower weight may be allocated to the block with fewer corresponding target pixels.

As yet another example, an initial weight of the gradient information to be blended may be first determined based on the number of target pixels corresponding to the at least one candidate block, and then the initial weight is adjusted based on the distance between the at least one candidate block and the current block to determine a target weight of the gradient information corresponding to the at least one candidate block. The basic manner of adjusting the initial weight may be to make the block that is closer to the current block among the at least one candidate block has a higher weight.

As mentioned above, multiple search positions are configured around the current block, and the search order for the multiple search positions is not specifically limited in the embodiments of the present disclosure. Some possible implementations are provided below.

In some implementations, the multiple search positions can be searched in a search order from near to far relative to the current block.

For example, as mentioned above, in some implementations, the spatial non-adjacent position around the current block may satisfy at least one of the following:
the absolute value of the horizontal offset between the spatial non-adjacent position and the top-left corner position of the current block is equal to iDistHor+1; or
the absolute value of the vertical offset between the spatial non-adjacent position and the top-left corner position of the current block is equal to iDistVer+1,
where iDistHor is equal to N times the width of the current block, iDist Ver is equal to N times the height of the current block, and Nis a positive integer greater than or equal to 1. For the spatial non-adjacent position that satisfies the above conditions, the smaller value of N corresponding to the spatial non-adjacent position indicates the closer distance of the spatial non-adjacent position to the current block, so the search order for the spatial non-adjacent block can be higher.

For example, as illustrated in FIG. 9, the spatial non-adjacent positions 14~16 satisfy the above conditions, and the value of N corresponding to the spatial non-adjacent positions 14~16 is 1. Therefore, the search order for the spatial non-adjacent positions 14~16 is relatively high (after the spatial adjacent position is searched, the spatial non-adjacent positions 14~16 can be searched). The spatial non-adjacent positions 17~21 satisfy the above conditions, and the value of N corresponding to the spatial non-adjacent positions 17~21 is 2. Therefore, the search order for the spatial non-adjacent positions 17~21 can be after the spatial non-adjacent positions 14~16. The spatial non-adjacent positions 22~26 satisfy the above conditions, and the value of N corresponding to the spatial non-adjacent positions 22~26 is 3. Therefore, the search order for the spatial non-adjacent positions 22~26 can be after the spatial non-adjacent positions 17~21. The spatial non-adjacent positions 27~31 satisfy the above conditions, and the value of N corresponding to the spatial non-adjacent positions 27~31 is 4. Therefore, the search order for the spatial non-adjacent positions 27~31 can be after the spatial non-adjacent positions 22~26. If the values of N corresponding to multiple spatial non-adjacent positions are equal, the order for the multiple spatial non-adjacent positions can be set randomly or determined according to certain rules. For example, the search position to the left of the current block is prioritized, followed by the search position above the current block, and then the search position at the top-left corner of the current block. Another example is that the search position above the current block is prioritized, followed by the search position left of the current block, and then the search position at the top-left corner of the current block.

In some implementations, the search order for multiple search positions can be determined based on the distances between the multiple search positions and the current block (which may refer to absolute distances, i.e., the absolute values of the distances). The definition manner of the distance between the search position and the current block is not specifically limited in the embodiments of the present disclosure. For example, the distance between the search position and the current block can be determined according to the distance between the search position and the top-left corner position of the current block. Another example is that the distance between the search position and the current block can be determined according to the distance between the search position and the center position of the current block. Yet another example is that the distance between the search position and the current block can be determined according to the distance between the search position and the top-right corner position of the current block. For example, the search order for multiple search positions is an ascending order of the distances between the multiple search positions and the current block. The closer the distance between the search position and the current block, the more similar the gradient information corresponding to the search position is to the gradient information of the current block. Such search positions are searched by priority, which helps to obtain useful reference information faster.

Furthermore, in some implementations, if two search positions among the multiple search positions have a same distance to the current block, the search order for the two search positions can be determined randomly.

Alternatively, if two search positions among the multiple search positions have a same distance to the current block, for the two search positions, a search position to the left of the current block is searched first, and then a search position above the current block is searched.

Alternatively, if two search positions among the multiple search positions have a same distance to the current block, for the two search positions, a search position above the current block is searched first, and then a search position to the left of the current block is searched.

In some implementations, gradient information (such as a gradient histogram) can be stored per coding block.

In some implementations, gradient information (such as the gradient histogram) can be stored per picture block of fixed size (or a storage unit of fixed size). The picture block of fixed size can be a picture block of a larger size such as 32*32 or 64*64. If gradient information is stored per picture block of fixed size, the pixel position to be searched can be directly divided by the storage unit to obtain the storage coordinate, and the gradient information corresponding to the storage coordinate can be found in the memory based on the storage coordinate. This storage manner of gradient information can save memory overhead and facilitate hardware implementation.

The specific size of the aforementioned picture block (or storage unit) can be determined based on the resolution of the current frame (i.e., adaptively selected according to the resolution of the current frame). For example, if the resolution of the current frame is smaller, a picture block (or storage unit) of a smaller size can be selected. If the resolution of the current frame is larger, a picture block (or storage unit) of a larger size can be selected.

As mentioned above, in some implementations, duplicate check can be performed on the candidate blocks in the candidate-block set. Whether two candidate blocks in the candidate-block set are duplicate can be determined based on at least one of the following: whether the two candidate blocks correspond to the same coding block, or whether the difference between the gradient information corresponding to the two candidate blocks satisfies a preset condition.

For example, if two candidate blocks in the candidate-block set correspond to the same coding block, it can be determined that the two candidate blocks are duplicate. In this case, only one candidate block can be retained.

Another example is that if the difference between the gradient information corresponding to two candidate blocks in the candidate-block set satisfies a preset condition, it can be determined that the two candidate blocks are duplicate. In this case, only one candidate block can be retained. The preset condition herein can be used for measuring the similarity between the gradient information corresponding to the two candidate blocks. That is to say, if the gradient information corresponding to the two candidate blocks are similar (or the HoG characteristics are consistent), it can be determined that the two candidate blocks are duplicate. The duplicate determination condition is introduced, which helps to remove redundant gradient information, thereby making the blending result of the gradient information more accurate.

There are multiple manners to determine whether two candidate blocks in the candidate-block set are similar. For example, for two candidate blocks corresponding to two gradient histograms respectively, whether the two candidate blocks are similar can be directly determined according to the similarity between the two gradient histograms. Alternatively, in some implementations, two sets of IPMs can be respectively determined according to the amplitudes corresponding to the IPMs in the two gradient histograms, and the determination can be made according to the similarity between the two sets of IPMs.

Exemplarily, the two candidate blocks in the candidate-block set include a first candidate block and a second candidate block. The first candidate block corresponds to a first gradient histogram, and the second candidate block corresponds to a second gradient histogram. S IPMs with the highest amplitudes in the first gradient histogram form a first set (that is, the amplitudes of the gradients corresponding to the SIPMs in the first gradient histogram are the highest, and S is a positive integer greater than or equal to 1, for example, S can be 3, 4, or 5). S IPMs with the highest amplitudes in the second gradient histogram form a second set (that is, the amplitudes of the gradients corresponding to the SIPMs in the second gradient histogram are the highest). Whether the gradient information corresponding to the two candidate blocks are similar (or whether the two candidate blocks are duplicate) can be determined based on whether the first set and the second set are similar.

In some implementations, whether the two candidate blocks are duplicate can be determined based on the number of identical IPMs included in the aforementioned first set and second set.

For example, if the number of identical IPMs included in the first set and the second set is greater than or equal to a first threshold, it can be determined that the two candidate blocks are duplicate. In other words, if the values of the IPMs in the first set and the second set highly overlap, it can be determined that the two candidate blocks are duplicate.

Another example is that if a ratio of an intersection of the first set and the second set to a union of the first set and the second set is greater than or equal to a third threshold (such as 0.5), the two candidate blocks are duplicate. Specifically, the similarity between the first set and the second set can be determined by calculating, according to the Jaccard similarity criterion, the ratio of the intersection of the first set and the second set to the union of the first set and the second set. The value of the Jaccard similarity index is between 0 and 1, where 1 indicates that the two sets are completely consistent, and 0 indicates that the two sets have no common elements. If the ratio of the intersection of the first set and the second set to the union of the first set and the second set is greater than 0.5, the first set and the second set are considered similar, and thus it can be determined that the two candidate blocks are duplicate.

In some implementations, whether the two candidate blocks are duplicate can be determined based on a difference between a first IPM in the first set and a second IPM in the second set, where the first set does not include the second IPM and the second set does not include the first IPM. That is to say, the first IPM and the second IPM are IPMs in which the first set and the second set differ.

For example, if the difference (or maximum difference) between the first IPM and the second IPM is less than or equal to a second threshold, it can be determined that the two candidate blocks are duplicate. For example, the second threshold can be 3, 4, or 5.

In some implementations, based on the size of the current block, at least one of the following can be determined: the number of candidate blocks in the candidate-block set, the number of gradient information to be blended (such as the number of gradient histograms to be blended), the number of IPMs used for determining the prediction value (this number can indicates how many prediction values under different IPMs need to be used for weighted blending to determine the prediction value of the current block). That is to say, one or more of the number of candidate blocks in the candidate-block set, the number of gradient information to be blended, and the number of IPMs used for determining the prediction value can be adaptively adjusted according to the size of the current block.

For example, for a block smaller than or equal to 16×16, the number of candidate blocks in the candidate-block set can be reduced. Exemplarily, for a block smaller than or equal to 16×16, the candidate-block set may only include 7 or 9 candidate blocks.

Another example is that for a block larger than 16×16, the number of candidate blocks in the candidate-block set can be increased.

Yet another example is that for a block smaller than or equal to 16×16, the number of gradient histograms to be blended can be reduced. Exemplarily, for a block smaller than or equal to 16×16, merely 3 gradient histograms can be used for arithmetic averaging to determine the gradient histogram corresponding to the current block.

Another example is that for a block larger than 16×16, the number of gradient histograms to be blended can be increased.

Yet another example is that for a block smaller than or equal to 16×16, a smaller number of IPMs can be used in weighted blending of prediction values of multiple IPMs to generate the prediction value of the current block. For example, the prediction values of merely 2 IPMs can be used for weighted blending to generate the prediction value of the current block.

Another example is that for a block larger than 16×16, a larger number of IPMs can be used in weighted blending of prediction values of multiple IPMs to generate the prediction value of the current block.

The aforementioned spatial non-adjacent position around the current block can be determined based on a certain search strategy. For example, the search distance and the search direction can be determined first, and then a two-dimensional searching is performed around the current block according to the search step and the search direction, with the position of the current block as the reference, to determine the spatial non-adjacent position around the current block.

Alternatively, in some implementations, the spatial non-adjacent position around the current block can be determined based on a pre-established first mapping relationship, where the first mapping relationship is a mapping relationship between indexes and coordinates of the spatial non-adjacent positions. For example, a one-dimensional list can be used for sequentially storing the mapping relationship between the indexes and the coordinates of the spatial non-adjacent positions to be searched by the current block, and the spatial non-adjacent position can be directly search according to the one-dimensional list in practical use.

Alternatively, in some implementations, the spatial non-adjacent position is determined based on a pre-established first mapping relationship and a pre-established second mapping relationship. The first mapping relationship is a mapping relationship between the indexes of the spatial non-adjacent positions and search distances (such as distances between the spatial non-adjacent positions and the top-left corner position of the current block), and the second mapping relationship is a mapping relationship between the indexes of the spatial non-adjacent positions and the search directions (such as directions of the spatial non-adjacent position relative to the current block). For example, one one-dimensional list can be used for storing the mapping relationship between the indexes of the spatial non-adjacent positions and the search distances, and another one-dimensional list can be used for storing the mapping relationship between the indexes of the spatial non-adjacent positions and the search directions. In practical use, coordinates of the spatial non-adjacent positions can be derived by combining the two one-dimensional lists, and then the spatial non-adjacent positions are determined according to the coordinates of the spatial non-adjacent positions.

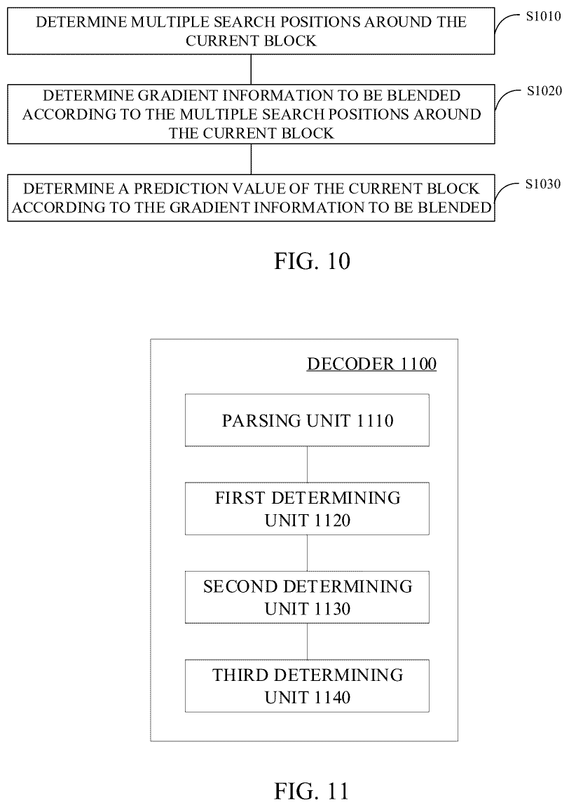

The decoding method provided in the embodiments of the present disclosure is described in detail above with reference to FIG. 8. The encoding method provided in the embodiments of the present disclosure will be described in detail with examples below with reference to FIG. 10.

FIG. 10 is a schematic flowchart of an encoding method provided in embodiments of the present disclosure. The method in FIG. 10 may also be referred to as an intra prediction method or a prediction method based on the DIMD Merge mode. The method in FIG. 10 can be applied to an encoder, for example, to an intra prediction unit of the encoder.

With reference to FIG. 10, in step S1010, multiple search positions around the current block are determined according to the first flag information.

The current block can also be referred to as the current coding block or the current coding unit. For example, the current block can be a luma block.

The intra prediction mode used for the current block can be a DIMD Merge mode.

In some implementations, the number of multiple search positions around the current block may be greater than 13. For example, the number of search positions around the current block may be greater than or equal to 16, 18, 21, 26, or 31. The number of search positions provided in the embodiments of the present disclosure is greater than the number of search positions provided by the related art (the related art provides 13 search positions). Therefore, the embodiments of the present disclosure search for candidate blocks in a larger search area or in more search positions, thereby helping to improve the accuracy of prediction.

In some implementations, the multiple search positions around the current block (or multiple search positions in the adjacent area of the current block) may include a spatial adjacent position (or an adjacent reference point) and/or a spatial non-adjacent position (or a non-adjacent reference point). For example, searching can be performed at X1 spatial adjacent positions and X2 spatial non-adjacent positions around the current block. A value of X1 may be, for example, less than or equal to 13. A value of X2 may be, for example, 3, 5, 8, 13, or 18. The embodiments of the present disclosure expand the search area, which helps to obtain more available candidate blocks, thereby helping to improve the accuracy of prediction.

In some implementations, the search positions around the current block include the spatial non-adjacent position, and the spatial non-adjacent position is determined based on a predefined position and/or a predefined size. The predefined size may include, for example, a predefined horizontal size (or horizontal step) and/or a predefined vertical size (or vertical step).

In some implementations, the aforementioned predefined position or spatial non-adjacent position may be determined based on one or more of the following:
a position of the current block (such as a top-left corner position of the current block);
a size of the current block (such as a width and/or height of the current block);
a size of an adjacent block of the current block (such as a width and/or height of the adjacent block);
the predefined horizontal size; or
the predefined vertical size.

In some implementations, the aforementioned predefined size (which may include the predefined horizontal size and/or the predefined vertical size) may be determined based on the size of the current block. For example, the predefined horizontal size is determined based on the width of the current block. For another example, the predefined vertical size is determined based on the height of the current block. As a more specific example, the predefined horizontal size is N times the width of the current block, and the predefined vertical size is N times the height of the current block, where N is a positive integer greater than or equal to 1.

In some implementations, the predefined size mentioned above (which may include the predefined horizontal size and/or the predefined vertical size) may be independent of the size of the current block. For example, both the predefined horizontal size and/or the predefined vertical size may be a fixed value, which may include, for example, one or more of 4, 8, 16, 32, and 64.

For example, the spatial non-adjacent position to be searched around the current block may satisfy at least one of the following:
an absolute value of a horizontal offset between the spatial non-adjacent position and the top-left corner position of the current block is equal to iDistHor+1 (hereinafter referred to as condition 1); or
an absolute value of a vertical offset between the spatial non-adjacent position and the top-left corner position of the current block is equal to iDistVer+1 (hereinafter referred to as condition 2),
where iDistHor is equal to the predefined horizontal size, and iDistVer is equal to the predefined vertical size.

In some implementations, iDistHor may be a fixed value (which may include, for example, one or more of 4, 8, 16, 32, and 64), or may be determined based on the size of the current block (such as the width of the current block). For example, iDistHor may be N times the width of the current block, where N is a positive integer greater than or equal to 1.

In some implementations, iDistVer may be a fixed value (which may include, for example, one or more of 4, 8, 16, 32, and 64), or may be determined based on the size of the current block (such as the height of the current block). For example, iDist Ver may be N times the height of the current block, where N is a positive integer greater than or equal to 1.

iDistHor and iDistVer can represent the search distance. iDistHor and/or iDistVer is determined based on the size of the current block, which enables the search distance to be adaptively adjusted based on the size of the current block, thus the found gradient information is also more accurate.

For example, as illustrated in FIG. 9, the spatial non-adjacent positions to be searched around the current block include search positions 14~16. As illustrated in FIG. 9, search position 14 satisfies condition 1, search position 15 satisfies condition 2, and search position 16 satisfies both condition 1 and condition 2. In addition, the value of N corresponding to search position 14~16 is 1, that is, iDistHor is equal to the width of the current block, and iDist Ver is equal to the height of the current block. In other words, the spatial non-adjacent positions 14~16 can be obtained by searching the search area defined by a one-time step, with the position of the current block as the starting position and the one-time step of the current block as the search step.

For example, as illustrated in FIG. 9, the spatial non-adjacent positions of the current block include search positions 17~21. As illustrated in FIG. 9, search position 17 satisfies condition 1, search position 18 satisfies Condition 2, search position 19 satisfies condition 2, search position 20 satisfies condition 1, and search position 21 satisfies both condition 1 and condition 2. In addition, the value of N corresponding to search positions 17~21 is 2, that is, iDistHor is equal to two times the width of the current block, and iDistVer is equal to two times the height of the current block. In other words, the spatial non-adjacent positions 17~21 can be obtained by searching the search area defined by a two-time step, with the position of the current block as the starting position and the two-time step of the current block as the search step.

For example, as illustrated in FIG. 9, the spatial non-adjacent positions of the current block include search positions 22~26. As illustrated in FIG. 9, search position 22 satisfies condition 1, search position 23 satisfies condition 2, search position 24 satisfies condition 2, search position 25 satisfies condition 1, and search position 26 satisfies both condition 1 and condition 2. In addition, the value of N corresponding to search positions 22~26 is 3, that is, iDistHor is equal to three times the width of the current block, and iDistVer is equal to three times the height of the current block. In other words, the spatial non-adjacent positions 22~26 can be obtained by searching the search area defined by a three-time step, with the position of the current block as the starting position and the three-time step of the current block as the search step.

For example, as illustrated in FIG. 9, the spatial non-adjacent positions of the current block include search positions 27~31. As illustrated in FIG. 9, search position 27 satisfies condition 1, search position 28 satisfies condition 2, search position 29 satisfies condition 2, search position 30 satisfies condition 1, and search position 31 satisfies both condition 1 and condition 2. In addition, the value of N corresponding to search positions 27~31 is 4, that is, iDistHor is equal to four times the width of the current block, and iDistVer is equal to four times the height of the current block. In other words, the spatial non-adjacent positions 27~31 can be obtained by searching the search area defined by a four-time step, with the position of the current block as the starting position and the four-time step of the current block as the search step.

As mentioned above, iDistHor is equal to N times the width of the current block, and iDistVer is equal to N times the height of the current block. Alternatively, iDistHor is equal to N times the width of the left adjacent block of the current block, and iDistVer is equal to N times the height of the upper adjacent block of the current block.

In some implementations, the value of N mentioned above may be less than or equal to 4. For example, the value of N includes 1, 2, 3, and 4. Alternatively, the value of N may also be greater than 4, such as 5, 6, or 7. The value of N is set to be less than or equal to 4, which can minimize the implementation complexity of the search process on the premise of obtaining sufficient gradient information.

In some implementations, the spatial non-adjacent position to be searched around the current block satisfies: xNb=xTL+offsetX, and yNb=yTL+offset, where the offsetX and the offsetY satisfy at least one of the following:

$$offsetX = uiWidth + iDistHor - 1 , and offsetY = - iDistVer - 1 ;$$

$$offsetX = uiWidth ≫ 1 , and offsetY = - iDistVer - 1 ;$$

$$offsetX = - iDistHor - 1 , and offsetY = - iDistVer - 1 ;$$

$$offsetX = - iDistHor - 1 , and offsetY = uiHeight ≫ 1 ; or$$

$$offsetX = - iDistHor - 1 , and offsetY = uiHeight + iDistVer - 1 ,$$

where xNb represents a horizontal coordinate of the spatial non-adjacent position, yNb represents a vertical coordinate of the spatial non-adjacent position, xTL represents a horizontal coordinate of the top-left corner position of the current block, yTL represents a vertical coordinate of the top-left corner position of the current block, uiWidth represents the width of the current block, and uiHeigth represents the height of the current block.

The above-mentioned spatial non-adjacent positions provided in the embodiments of the present disclosure are uniformly distributed around the current block, so that as much available gradient information as possible can be found with as few search positions as possible.

For example, as illustrated in FIG. 9, assume that N=1, then iDistHor is equal to the width of the current block, and iDistVer is equal to the height of the current block. Furthermore, if offsetX=uiWidth+iDistHor−1 and offsetY=−iDistVer−1, the spatial non-adjacent position (xNb, yNB) refers to search position 15 in FIG. 9. If offsetX=uiWidth>>1 and offsetY=−iDistVer−1, the spatial non-adjacent position (xNb, yNB) is above the current block and has the same horizontal position as search position 15 (this search position is not numbered in FIG. 9). If offsetX=−iDistHor−1 and offsetY=−iDistVer−1, the spatial non-adjacent position (xNb, yNB) refers to search position 16 in FIG. 9. If offsetX=−iDistHor−1 and offsetY=uiHeigth>>1, the spatial non-adjacent position (xNb, yNB) is directly left of the current block and has the same vertical position as search position 16 (this search position is not numbered in FIG. 9). If offsetX=−iDistHor−1 and offsetY=uiHeigth+iDistVer−1, the spatial non-adjacent position (xNb, yNB) refers to search position 14 in FIG. 9. Furthermore, in some implementations, when N=1, the offsetX and the offsetY satisfy at least one of the following: offsetX=uiWidth+iDistHor−1 and offsetY=−iDistVer−1; offsetX=−iDistHor−1 and offsetY=−iDistVer−1; or offsetX=−iDistHor−1 and offsetY=uiHeigth+iDistVer−1. For example, as illustrated in FIG. 9, when N=1, the spatial non-adjacent position (xNb, yNB) may include the positions of search positions 14~16 in FIG. 9.

For example, as illustrated in FIG. 9, assume that N=2, then iDistHor is equal to two times the width of the current block, and iDistVer is equal to two times the height of the current block. Furthermore, if offsetX=uiWidth+iDistHor−1 and offsetY=−iDistVer−1, the spatial non-adjacent position (xNb, yNB) refers to search position 18 in FIG. 9. If offsetX=uiWidth>>1 and offsetY=−iDistVer−1, the spatial non-adjacent position (xNb, yNB) refers to search position 19 in FIG. 9. If offsetX=−iDistHor−1 and offsetY=−iDistVer−1, the spatial non-adjacent position (xNb, yNB) refers to search position 21 in FIG. 9. If offsetX=−iDistHor−1 and offsetY=uiHeigth>>1, the spatial non-adjacent position (xNb, yNB) refers to search position 20 in FIG. 9. If offsetX=−iDistHor−1 and offsetY=uiHeigth+iDistVer−1, the spatial non-adjacent position (xNb, yNB) refers to search position 17 in FIG. 9.

For example, as illustrated in FIG. 9, assume that N=3, then iDistHor is equal to three times the width of the current block, and iDist Ver is equal to three times the height of the current block. Furthermore, if offsetX=uiWidth+iDistHor−1 and offsetY=−iDistVer−1, the spatial non-adjacent position (xNb, yNB) refers to search position 23 in FIG. 9. If offsetX=uiWidth>>1 and offsetY=−iDistVer−1, the spatial non-adjacent position (xNb, yNB) refers to search position 24 in FIG. 9. If offsetX=−iDistHor−1 and offsetY=−iDistVer−1, the spatial non-adjacent position (xNb, yNB) refers to search position 26 in FIG. 9. If offsetX=−iDistHor−1 and offsetY=uiHeigth>>1, the spatial non-adjacent position (xNb, yNB) refers to search position 25 in FIG. 9. If offsetX=−iDistHor−1 and offsetY=uiHeigth+iDistVer−1, the spatial non-adjacent position (xNb, yNB) refers to search position 22 in FIG. 9.

For example, as illustrated in FIG. 9, assume that N=4, then iDistHor is equal to four times the width of the current block, and iDistVer is equal to four times the height of the current block. Furthermore, if offsetX=uiWidth+iDistHor−1 and offsetY=−iDistVer−1, the spatial non-adjacent position (xNb, yNB) refers to search position 28 in FIG. 9. If offsetX=uiWidth>>1 and offsetY=-iDist Ver-1, the spatial non-adjacent position (xNb, yNB) refers to search position 29 in FIG. 9. If offsetX=−iDistHor−1 and offsetY=−iDistVer−1, the spatial non-adjacent position (xNb, yNB) refers to search position 31 in FIG. 9. If offsetX=−iDistHor−1 and offsetY=uiHeigth>>1, the spatial non-adjacent position (xNb, yNB) refers to search position 30 in FIG. 9. If offsetX=−iDistHor−1 and offsetY=uiHeigth+iDistVer−1, the spatial non-adjacent position (xNb, yNB) refers to search position 27 in FIG. 9.

In some implementations, the spatial non-adjacent position around the current block satisfies at least one of the following: being at the top-right of the current block, being above the current block, being at the top-left of the current block, being to the left of the current block, or being at the bottom-left of the current block. If the direction of the horizontal coordinate is taken as the reference, the spatial non-adjacent position around the current block satisfies at least one of the following: being at the 45° direction of the current block, being at the 90° direction of the current block, being at the 135° direction of the current block, being at the 180° direction of the current block, or being at the 225° direction of the current block. The above directions can be referred to the search directions for the spatial non-adjacent positions around the current block. In other words, searching can be performed along the above directions with the position of the current block as the reference to determine the spatial non-adjacent positions of the current block. The search step in each search direction can be determined based on N (or iDistHor and iDistVer) mentioned above. The above-mentioned spatial non-adjacent positions provided in the embodiments of the present disclosure are uniformly distributed around the current block, so that as much available gradient information as possible can be found with as few search positions as possible.

In some implementations, the number of search positions and/or the size of the search range can be adaptively adjusted. For example, the number of search positions and/or the size of the search range can be determined based on the size of the current block. The number of search positions and/or the size of the search range is adaptively adjusted according to the size of the current block, which can make the found gradient information more accurate.

As an example, the value range of N (or iDistHor and iDistVer) mentioned above can be determined according to the size of the current block. For example, if the size of the current block is a first size, the value range of N is a first value range. If the size of the current block is a second size, the value range of N is a second value range. Furthermore, in some implementations, if the first size is smaller than the second size, the first value range is narrower than the second value range. In other words, if the current block is a small block, the search range of the spatial non-adjacent positions of the current block is reduced. If the current block is a large block, the search range of the spatial non-adjacent positions of the current block is expanded. In this way, the prediction process are more flexible. For example, if the size of the current block is the first size, the value range of Nis 1~3. If the size of the current block is the second size (larger than the first size), the value range of Nis 1~4.

As another example, if the size of the current block is smaller than a preset size (such as 16×16), the spatial adjacent position of the current block may not include at least one of the following positions:
a first position, corresponding to the 1/4 position of the height of the current block (with reference to search position 10 in FIG. 6);
a second position, corresponding to the 1/4 position of the width of the current block (with reference to search position 11 in FIG. 6);
a third position, corresponding to the 3/4 position of the height of the current block (with reference to search position 12 in FIG. 6);
a fourth position, corresponding to the 3/4 position of the width of the current block (with reference to search position 13 in FIG. 6);
a fifth position, corresponding to the 1/2 position of the height of the current block (with reference to search position 8 in FIG. 6); or
a sixth position, corresponding to the 1/2 position of the width of the current block (with reference to search position 9 in FIG. 6).

As yet another example, the above two examples can be combined together. For example, if the size of the current block is smaller than a preset size (such as 16×16), the value range of N can be limited to the second value range (such as 1~3), thereby reducing the number of spatial non-adjacent positions to be searched. Furthermore, one or more positions among the above-mentioned first to sixth position can be removed (such as the first to the fourth position are removed at the same time), thereby reducing the number of spatial adjacent positions to be searched.

In step S1020, gradient information to be blended is determined according to multiple search positions around the current block.

In some implementations, step S1020 may include the following. A candidate-block set (such as a candidate list) is determined according to multiple search positions around the current block. The gradient information to be blended is determined according to the candidate-block set. The candidate-block set may be determined according to multiple search positions around the current block as follows. The candidate blocks corresponding to the multiple search positions are added to the candidate-block set. The gradient information to be blended may be determined according to the candidate-block set as follows. The candidate blocks in the candidate-block set are sorted, and the gradient information corresponding to one or more candidate blocks ranked highest is used as the gradient information to be blended.

The form or content of gradient information is not specifically limited by the embodiments of the present disclosure. For example, in some implementations, the gradient information may be gradient histogram information (or HoG information). The gradient histogram information may also be referred to or replaced with angular mode HoG information. In other implementations, the gradient information may include a set of IPMs and corresponding amplitudes of the set of IPMs. The set of IPMs may be, for example, a set of IPMs with the highest amplitudes in the gradient histogram. The set of IPMs may include 3 IPMs, 5 IPMs, or other numbers of IPMs.

In some implementations, the gradient information to be blended may be gradient information corresponding to K candidate blocks, where K is a positive integer greater than 3. For example, the value of K may be 5. Another example is that the value of K may be greater than 5, such as 6, 7, or 8. The K candidate blocks mentioned herein may be determined based on multiple search positions around the current block. For example, the candidate-block set (such as the candidate list, which can be used for storing coding block information corresponding to the search position) may be determined according to multiple search positions around the current block, and the K candidate blocks may be determined from the candidate-block set. The manner of determining K candidate blocks from the candidate-block set may include the following. For example, the candidate blocks in the candidate-block set are sorted (such as according to the distance between the top-left corner position of the candidate block and the top-left corner position of the current block), and then the gradient information corresponding to the top K candidate blocks after sorting is determined as the gradient information to be blended. Furthermore, in some implementations, if the number of available candidate blocks in the candidate-block set is less than K, the gradient information to be blended may be the gradient information corresponding to all available candidate blocks. By increasing the number of candidate blocks used for providing gradient information (in related art, K=3), the accuracy of the blended gradient information can be improved, thereby improving the accuracy of prediction.

In some implementations, the gradient information to be blended is K gradient histograms, where K is a positive integer greater than 3. For example, the value of K may be 5, or the value of K may be greater than 5, such as 6, 7, or 8.

In some implementations, the gradient information to be blended is amplitudes corresponding to K sets of IPMs, where K is a positive integer greater than 3. For example, the value of K may be 5, or the value of K may be greater than 5, such as 6, 7, or 8. Each set of IPMs may include 3, 5, or more IPMs.

In some implementations, the gradient information to be blended is determined based on the candidate-block set. The candidate-block set may be determined based on multiple search positions around the current block. The candidate-block set may include duplicate candidate blocks or no duplicate candidate blocks. For example, the candidate-block set (such as the candidate list, which can be used for storing the coding block information corresponding to the search position) may be determined according to multiple search positions around the current block. A duplicate check may be performed on the candidate blocks in the candidate-block set. If the candidate-block set includes duplicate candidate blocks, only one candidate block of the duplicate blocks is retained. The duplicate check is introduced, which can avoid redundant gradient information, thereby improving the accuracy of prediction.

In some implementations, the gradient information to be blended is gradient information corresponding to at least one candidate block in the candidate-block set. The candidate-block set may be determined based on multiple search positions around the current block. The candidate-block set may include M candidate blocks (where Mis a positive integer greater than or equal to 1), and the order of the M candidate blocks in the candidate-block set is determined based on the distances between the M candidate blocks and the current block. The M candidate blocks are sorted according to the distances between the candidate blocks and the current block, which can help to preferentially find gradient information corresponding to a nearer search position.

The distances between the M candidate blocks and the current block may be defined in different manners. For example, the distances between the top-left corner positions of the M candidate blocks and the top-left corner position of the current block may be used as the distances between the M candidate blocks and the current block. Another example is that the distances between the center positions of the M candidate blocks and the center position of the current block may be used as the distances between the M candidate blocks and the current block.

As an example, the M candidate blocks include a first candidate block (which may be any candidate block among the M candidate blocks). The distance between the first candidate block and the current block is determined based on a difference between a first distance and a second distance. The first distance represents a horizontal distance between the top-left corner position of the first candidate block and the top-left corner position of the current block, and the second distance represents a vertical distance between the top-left corner position of the first candidate block and the top-left corner position of the current block. For example, the distance between the first candidate block and the current block satisfies: (abs(xTL−xNeiTL)+abs(yTL−yNeiTL)+abs(abs(xTL−xNeiTL)−abs(yTL−yNeiTL))), where xTL represents the horizontal coordinate of the top-left corner position of the current block, yTL represents the vertical coordinate of the top-left corner position of the current block, xNeiTL represents the horizontal coordinate of the top-left corner position of the first candidate block, yNeiTL represents the vertical coordinate of the top-left corner position of the first candidate block, and abs represents an absolute value operation. The distance determined by the above distance determination manner is close to the Euclidean distance between the two positions, thus the distance is also more accurate. In a specific implementation process, deltaX=abs(xTL−xNeiTL) and deltaY=abs(yTL−yNeiTL) may be calculated first, and then (deltaX+deltaY+abs(deltaX-delta Y)) is calculated, thereby avoiding unnecessary redundant calculations.

As another example, the M candidate blocks include a second candidate block (which may be any candidate block among the M candidate blocks). The distance between the second candidate block and the current block satisfies: (abs(xTL−xNeiTL)+abs(yTL−yNeiTL)), where xTL represents the horizontal coordinate of the top-left corner position of the current block, yTL represents the vertical coordinate of the top-left corner position of the current block, xNeiTL represents the horizontal coordinate of the top-left corner position of the second candidate block, yNeiTL represents the vertical coordinate of the top-left corner position of the second candidate block, and abs represents the absolute value operation. The above distance determination manner is compatible with the distance determination manner provided by related art.

In some implementations, if two candidate blocks among the M candidate blocks have a same distance to the current block, for the two candidate blocks, the order of the candidate block to the left of the current block is higher than the order of the candidate block above the current block. For example, for the two candidate blocks, the priority of the candidate block to the left of the current block is higher than the priority of the candidate block above the current block. Alternatively, for the two candidate blocks, the value of the index of the candidate block to the left of the current block is smaller than the value of the index of the candidate block above the current block.

In some implementations, if two candidate blocks among the M candidate blocks have a same distance to the current block, for the two candidate blocks, the order of the candidate block above the current block is higher than the order of the candidate block to the left of the current block. For example, for the two candidate blocks, the priority of the candidate block above the current block is higher than the priority of the candidate block to the left of the current block. Alternatively, for the two candidate blocks, the value of the index of the candidate block above the current block is smaller than the value of the index of the candidate block to the left of the current block.

In step S1030, a prediction value of the current block is determined according to the gradient information to be blended.

In some implementations, step S1030 may include the following. Target gradient information is determined according to the gradient information to be blended. The prediction value of the current block is determined according to the target gradient information. The target gradient information may be, for example, the gradient information corresponding to the current block.

In some implementations, the target gradient information may be determined according to the gradient information to be blended as follows. Arithmetic averaging is performed on the gradient information to be blended to determine the target gradient information.

In some implementations, the prediction value of the current block may be determined according to the target gradient information as follows. One or more IPMs are determined according to the target gradient information. Intra prediction is performed on the current block according to the one or more IPMs to determine one or more prediction values. The prediction value of the current block is determined according to the one or more prediction values. For detailed descriptions, reference may be taken to S1.2 above.

In some implementations, the gradient information to be blended may be gradient information corresponding to at least one candidate block. The at least one candidate block may be determined from the candidate-block set, and the candidate-block set may be determined based on multiple search positions around the current block. Furthermore, in some implementations, normalization may be performed on the gradient information corresponding to the at least one candidate block according to the size (or block size) of the at least one candidate block to determine the gradient information to be blended. For example, at least one gradient histogram which corresponds one-to-one to the at least one candidate block may be determined first, and then the amplitude (or intensity) corresponding to each IPM in the at least one gradient histogram may be normalized according to the size of the at least one candidate block, and the normalized gradient histogram is used as the gradient information to be blended. Normalization is performed on the gradient information corresponding to the candidate block according to the size of the candidate block, which can help to improve the accuracy of gradient information blending.

In some implementations, arithmetic averaging or weighted averaging may be performed on the gradient information to be blended to determine target gradient information. The prediction value of the current block is determined according to the target gradient information. For example, for the gradient information to be blended included one or more gradient histograms, the one or more gradient histograms may be weighted to obtain the gradient histogram corresponding to the current block (i.e., target gradient information). The prediction value of the current block may be determined according to the gradient histogram corresponding to the current block. The weighted averaging is performed on different gradient information to be blended, which can help to improve the accuracy of gradient information blending.

The manner of determining the weight of the gradient information to be blended is not specifically limited in the embodiments of the present disclosure. For example, as mentioned above, the gradient information to be blended may be gradient information corresponding to at least one candidate block in the candidate-block set. Therefore, in some implementations, the weight of the gradient information to be blended may be determined according to the at least one candidate block.

As an example, the weight of the gradient information to be blended may be determined according to the distance between the at least one candidate block and the current block. For example, a higher weight may be set for the gradient information corresponding to the candidate block that is closer to the current block among the at least one candidate block, and a lower weight may be set for the gradient information corresponding to the candidate block that is farther from the current block among the at least one candidate block.

As another example, the weight of the gradient information to be blended may be determined according to the size of the at least one candidate block. For example, a higher weight may be allocated to the block with a larger size among the at least one candidate block, and a lower weight may be allocated to the block with a smaller size.

As yet another example, the weight of the gradient information to be blended may be determined according to the number of target pixels corresponding to the at least one candidate block. The target pixels are pixels required for determining gradient information in the DIMD mode. The target pixels corresponding to the at least one candidate block may be determined based on the size and/or position of the at least one candidate block. For example, a higher weight may be allocated to the block with more corresponding target pixels among the at least one candidate block, and a lower weight may be allocated to the block with fewer corresponding target pixels.

As yet another example, an initial weight of the gradient information to be blended may be first determined based on the number of target pixels corresponding to the at least one candidate block, and then the initial weight is adjusted based on the distance between the at least one candidate block and the current block to determine a target weight of the gradient information corresponding to the at least one candidate block. The basic manner of adjusting the initial weight may be to make the block that is closer to the current block among the at least one candidate block has a higher weight.

As mentioned above, multiple search positions are configured around the current block, and the search order for the multiple search positions is not specifically limited in the embodiments of the present disclosure. Some possible implementations are provided below.

In some implementations, the multiple search positions can be searched in a search order from near to far relative to the current block.

For example, as mentioned above, in some implementations, the spatial non-adjacent position around the current block may satisfy at least one of the following:
the absolute value of the horizontal offset between the spatial non-adjacent position and the top-left corner position of the current block is equal to iDistHor+1; or
the absolute value of the vertical offset between the spatial non-adjacent position and the top-left corner position of the current block is equal to iDistVer+1,
where iDistHor is equal to N times the width of the current block, iDist Ver is equal to N times the height of the current block, and N is a positive integer greater than or equal to 1. For the spatial non-adjacent position that satisfies the above conditions, the smaller value of N corresponding to the spatial non-adjacent position indicates the closer distance of the spatial non-adjacent position to the current block, so the search order for the spatial non-adjacent block can be higher.

For example, as illustrated in FIG. 9, the spatial non-adjacent positions 14~16 satisfy the above conditions, and the value of N corresponding to the spatial non-adjacent positions 14~16 is 1. Therefore, the search order for the spatial non-adjacent positions 14~16 is relatively high (after the spatial adjacent position is searched, the spatial non-adjacent positions 14~16 can be searched). The spatial non-adjacent positions 17~21 satisfy the above conditions, and the value of N corresponding to the spatial non-adjacent positions 17~21 is 2. Therefore, the search order for the spatial non-adjacent positions 17~21 can be after the spatial non-adjacent positions 14~16. The spatial non-adjacent positions 22~26 satisfy the above conditions, and the value of N corresponding to the spatial non-adjacent positions 22~26 is 3. Therefore, the search order for the spatial non-adjacent positions 22~26 can be after the spatial non-adjacent positions 17~21. The spatial non-adjacent positions 27~31 satisfy the above conditions, and the value of N corresponding to the spatial non-adjacent positions 27~31 is 4. Therefore, the search order for the spatial non-adjacent positions 27~31 can be after the spatial non-adjacent positions 22~26. If the values of N corresponding to multiple spatial non-adjacent positions are equal, the order for the multiple spatial non-adjacent positions can be set randomly or determined according to certain rules. For example, the search position to the left of the current block is prioritized, followed by the search position above the current block, and then the search position at the top-left corner of the current block. Another example is that the search position above the current block is prioritized, followed by the search position left of the current block, and then the search position at the top-left corner of the current block.

In some implementations, the search order for multiple search positions can be determined based on the distances between the multiple search positions and the current block (which may refer to absolute distances, i.e., the absolute values of the distances). The definition manner of the distance between the search position and the current block is not specifically limited in the embodiments of the present disclosure. For example, the distance between the search position and the current block can be determined according to the distance between the search position and the top-left corner position of the current block. Another example is that the distance between the search position and the current block can be determined according to the distance between the search position and the center position of the current block. Yet another example is that the distance between the search position and the current block can be determined according to the distance between the search position and the top-right corner position of the current block. For example, the search order for multiple search positions is an ascending order of the distances between the multiple search positions and the current block. The closer the distance between the search position and the current block, the more similar the gradient information corresponding to the search position is to the gradient information of the current block. Such search positions are searched by priority, which helps to obtain useful reference information faster.

Furthermore, in some implementations, if two search positions among the multiple search positions have a same distance to the current block, the search order for the two search positions can be determined randomly.

Alternatively, if two search positions among the multiple search positions have a same distance to the current block, for the two search positions, a search position to the left of the current block is searched first, and then a search position above the current block is searched.

Alternatively, if two search positions among the multiple search positions have a same distance to the current block, for the two search positions, a search position above the current block is searched first, and then a search position to the left of the current block is searched.

In some implementations, gradient information (such as a gradient histogram) can be stored per coding block.

In some implementations, gradient information (such as the gradient histogram) can be stored per picture block of fixed size (or a storage unit of fixed size). The picture block of fixed size can be a picture block of a larger size such as 32*32 or 64*64. If gradient information is stored per picture block of fixed size, the pixel position to be searched can be directly divided by the storage unit to obtain the storage coordinate, and the gradient information corresponding to the storage coordinate can be found in the memory based on the storage coordinate. This storage manner of gradient information can save memory overhead and facilitate hardware implementation.

The specific size of the aforementioned picture block (or storage unit) can be determined based on the resolution of the current frame (i.e., adaptively selected according to the resolution of the current frame). For example, if the resolution of the current frame is smaller, a picture block (or storage unit) of a smaller size can be selected. If the resolution of the current frame is larger, a picture block (or storage unit) of a larger size can be selected.

As mentioned above, in some implementations, duplicate check can be performed on the candidate blocks in the candidate-block set. Whether two candidate blocks in the candidate-block set are duplicate can be determined based on at least one of the following: whether the two candidate blocks correspond to the same coding block, or whether the difference between the gradient information corresponding to the two candidate blocks satisfies a preset condition.

For example, if two candidate blocks in the candidate-block set correspond to the same coding block, it can be determined that the two candidate blocks are duplicate. In this case, only one candidate block can be retained.

Another example is that if the difference between the gradient information corresponding to two candidate blocks in the candidate-block set satisfies a preset condition, it can be determined that the two candidate blocks are duplicate. In this case, only one candidate block can be retained. The preset condition herein can be used for measuring the similarity between the gradient information corresponding to the two candidate blocks. That is to say, if the gradient information corresponding to the two candidate blocks are similar (or the HoG characteristics are consistent), it can be determined that the two candidate blocks are duplicate. The duplicate determination condition is introduced, which helps to remove redundant gradient information, thereby making the blending result of the gradient information more accurate.

There are multiple manners to determine whether two candidate blocks in the candidate-block set are similar. For example, for two candidate blocks corresponding to two gradient histograms respectively, whether the two candidate blocks are similar can be directly determined according to the similarity between the two gradient histograms. Alternatively, in some implementations, two sets of IPMs can be respectively determined according to the amplitudes corresponding to the IPMs in the two gradient histograms, and the determination can be made according to the similarity between the two sets of IPMs.

Exemplarily, the two candidate blocks in the candidate-block set include a first candidate block and a second candidate block. The first candidate block corresponds to a first gradient histogram, and the second candidate block corresponds to a second gradient histogram. S IPMs with the highest amplitudes in the first gradient histogram form a first set (that is, the amplitudes of the gradients corresponding to the SIPMs in the first gradient histogram are the highest, and Sis a positive integer greater than or equal to 1, for example, S can be 3, 4, or 5). S IPMs with the highest amplitudes in the second gradient histogram form a second set (that is, the amplitudes of the gradients corresponding to the SIPMs in the second gradient histogram are the highest). Whether the gradient information corresponding to the two candidate blocks are similar (or whether the two candidate blocks are duplicate) can be determined based on whether the first set and the second set are similar.

In some implementations, whether the two candidate blocks are duplicate can be determined based on the number of identical IPMs included in the aforementioned first set and second set.

For example, if the number of identical IPMs included in the first set and the second set is greater than or equal to a first threshold, it can be determined that the two candidate blocks are duplicate. In other words, if the values of the IPMs in the first set and the second set highly overlap, it can be determined that the two candidate blocks are duplicate.

Another example is that if a ratio of an intersection of the first set and the second set to a union of the first set and the second set is greater than or equal to a third threshold (such as 0.5), the two candidate blocks are duplicate. Specifically, the similarity between the first set and the second set can be determined by calculating, according to the Jaccard similarity criterion, the ratio of the intersection of the first set and the second set to the union of the first set and the second set. The value of the Jaccard similarity index is between 0 and 1, where 1 indicates that the two sets are completely consistent, and 0 indicates that the two sets have no common elements. If the ratio of the intersection of the first set and the second set to the union of the first set and the second set is greater than 0.5, the first set and the second set are considered similar, and thus it can be determined that the two candidate blocks are duplicate.

In some implementations, whether the two candidate blocks are duplicate can be determined based on a difference between a first IPM in the first set and a second IPM in the second set, where the first set does not include the second IPM and the second set does not include the first IPM. That is to say, the first IPM and the second IPM are IPMs in which the first set and the second set differ.

For example, if the difference (or maximum difference) between the first IPM and the second IPM is less than or equal to a second threshold, it can be determined that the two candidate blocks are duplicate. For example, the second threshold can be 3, 4, or 5.

In some implementations, based on the size of the current block, at least one of the following can be determined: the number of candidate blocks in the candidate-block set, the number of gradient information to be blended (such as the number of gradient histograms to be blended), the number of IPMs used for determining the prediction value (this number can indicates how many prediction values under different IPMs need to be used for weighted blending to determine the prediction value of the current block). That is to say, one or more of the number of candidate blocks in the candidate-block set, the number of gradient information to be blended, and the number of IPMs used for determining the prediction value can be adaptively adjusted according to the size of the current block.

For example, for a block smaller than or equal to 16×16, the number of candidate blocks in the candidate-block set can be reduced. Exemplarily, for a block smaller than or equal to 16×16, the candidate-block set may only include 7 or 9 candidate blocks.

Another example is that for a block larger than 16×16, the number of candidate blocks in the candidate-block set can be increased.

Yet another example is that for a block smaller than or equal to 16×16, the number of gradient histograms to be blended can be reduced. Exemplarily, for a block smaller than or equal to 16×16, merely 3 gradient histograms can be used for arithmetic averaging to determine the gradient histogram corresponding to the current block.

Another example is that for a block larger than 16×16, the number of gradient histograms to be blended can be increased.

Yet another example is that for a block smaller than or equal to 16×16, a smaller number of IPMs can be used in weighted blending of prediction values of multiple IPMs to generate the prediction value of the current block. For example, the prediction values of merely 2 IPMs can be used for weighted blending to generate the prediction value of the current block.

Another example is that for a block larger than 16×16, a larger number of IPMs can be used in weighted blending of prediction values of multiple IPMs to generate the prediction value of the current block.

The aforementioned spatial non-adjacent position around the current block can be determined based on a certain search strategy. For example, the search distance and the search direction can be determined first, and then a two-dimensional searching is performed around the current block according to the search step and the search direction, with the position of the current block as the reference, to determine the spatial non-adjacent position around the current block.

Alternatively, in some implementations, the spatial non-adjacent position around the current block can be determined based on a pre-established first mapping relationship, where the first mapping relationship is a mapping relationship between indexes and coordinates of the spatial non-adjacent positions. For example, a one-dimensional list can be used for sequentially storing the mapping relationship between the indexes and the coordinates of the spatial non-adjacent positions to be searched by the current block, and the spatial non-adjacent position can be directly search according to the one-dimensional list in practical use.

Alternatively, in some implementations, the spatial non-adjacent position is determined based on a pre-established first mapping relationship and a pre-established second mapping relationship. The first mapping relationship is a mapping relationship between the indexes of the spatial non-adjacent positions and search distances (such as distances between the spatial non-adjacent positions and the top-left corner position of the current block), and the second mapping relationship is a mapping relationship between the indexes of the spatial non-adjacent positions and the search directions (such as directions of the spatial non-adjacent position relative to the current block). For example, one one-dimensional list can be used for storing the mapping relationship between the indexes of the spatial non-adjacent positions and the search distances, and another one-dimensional list can be used for storing the mapping relationship between the indexes of the spatial non-adjacent positions and the search directions. In practical use, coordinates of the spatial non-adjacent positions can be derived by combining the two one-dimensional lists, and then the spatial non-adjacent positions are determined according to the coordinates of the spatial non-adjacent positions.

In some implementations, the first flag information (such as a DIMD Merge flag) can be signalled into a bitstream. The first flag information indicates that the DIMD Merge mode is used for the current block. The first flag information may include, for example, a first value and a second value. The first value may be 1 or true. The first value can indicate that the DIMD Merge mode is used for the current block. The second value may be 0 or false. The second value can indicate that the DIMD Merge mode is not used for the current block. If the DIMD Merge mode is not used for the current block, prediction can be performed on the current block based on the DIMD mode.

The following describes the embodiments of the present disclosure in more detail with specific examples. It should be noted that the following examples are only intended to help those skilled in the art understand the embodiments of the present disclosure, and are not intended to limit the embodiments of the present disclosure to the specific values or specific scenarios illustrated. It is obvious that those skilled in the art can make various equivalent modifications or changes based on the given examples, and such modifications or changes also fall within the scope of the embodiments of the present disclosure.

In the process of deriving the intra prediction mode based on DIMD merge, coding blocks at spatial non-adjacent positions in a larger search area can be added to the candidate list. S1: DIMD mode

For the implementation of S1, reference can be taken to the above content, which will not be repeated herein.

### S2.1 DIMD Merge Intra Mode Derivation

The input of step S2.1 may include the following information:
Top-left corner position (xTL, yTL) of the current luma block, bottom-left corner position (xLB, yLB) of the current luma block, top-right corner position (xRT, yRT) of the current luma block;
Width uiWidth of the current luma block and height uiHeigth of the current luma block;
Adjacent positions (xNb[idx], yNb[idx]) of the current luma block, where idx=1, . . . ,31; and
Corresponding CU at the adjacent position (xNb[idx], yNb[idx]), denoted as cuNeibor[idx], where idx=1, . . . ,31.

The output of step S2.1 varies in different scenarios. In the scenario of obtaining DIMD intra prediction values, the output of step S2.1 is histogram information. In another application scenario, the output of step S2.1 may be a traditional intra prediction mode IntraPredModeD, where the value of IntraPredModeD ranges between [0,66].

The process of deriving the traditional intra prediction mode through gradient analysis after expanding the search area by DIMD merge is described in detail below.

Step a, cuNeibor[idx] corresponding to adjacent positions of the current block are searched, and corresponding coding blocks are added to the candidate list according to a search order. When adding cuNeibor[idx] to the candidate list, whether each cuNeibor[idx] in the candidate list is present, is duplicate, and is in the DIMD or DIMD Merge mode are checked. The adjacent positions to be searched and the search order for the adjacent positions are illustrated in FIG. 9. If there are duplicate cuNeibor[idx] in the candidate list, only one candidate block is retained.

The cuNeibor[idx] corresponding to the adjacent positions is obtained, and the coding blocks corresponding to 13 spatial adjacent positions and 18 spatial non-adjacent positions of the current block are taken as candidates in the candidate list.
i. For cuNeibor[idx] corresponding to the spatial adjacent position, the selection manner can take reference to the related art;
ii. For cuNeibor[idx] corresponding to the spatial non-adjacent position, the search distance can be determined based on the width (uiWidth) and height (uiHeigth) of the current block, the search positions are the positions corresponding to 14-31 in FIG. 9, and the search order can be determined based on a near-to-far criterion.

The specific search process is as follows.

Searching is performed in different directions for the current block. The search directions may include 45°, vertical 90°, 135°, horizontal 180°, and 225° directions. The search step takes the width and height of the current block as a step reference, and the search range is expanded to an area of 4 times the step reference. In addition, in the horizontal 180° and vertical 90° directions, searching within 1 time the step reference is not performed.

Five directions angle [5]={0, 1, 2, 3, 4} are defined, corresponding to 45°, vertical 90°, 135°, horizontal 180°, and 225° directions respectively. The numbers of directions to be searched for different search steps are denoted as numAng[4]={3, 5, 5, 5}. The specific search directions are determined through iMap[4][5], where iMap[4][5]={{0, 2, 4}, {0, 1, 2, 3, 4}, {0, 1, 2, 3, 4}, {0, 1, 2, 3, 4}} indicates the directions to be searched for each search step. The search steps are as follows:
step 1, searching directions angle[0], angle[2], and angle[4];
step 2, searching directions angle[0], angle[1], angle[2], angle[3], and angle[4];
step 3, searching directions angle[0], angle[1], angle[2], angle[3], and angle[4]; and
step 4, searching directions angle[0], angle[1], angle[2], angle[3], and angle[4].

The corresponding search operation is performed then. The search process can be implemented with the following codes:

```
  for (int iDistIdx = 1; iDistIdx <= 4; iDistIdx ++)// search step iteration
  {
    int iDistHor = uiWidth * iDistIdx ;// horizontal search distance
    int iDistVer = uiHeigth * iDistIdx ;// vertical search distance
    for (int angleIdx= 0; angleIdx < numAng [iDistIdx − 1]; angleIdx ++) // directions to be
searched for each search step
  {
  switch (iMap[iDistIdx −1][angleIdx])// obtain the final coordinate offsets in different
directions
  {
  case 0: offsetX = uiWidth + iDistHor − 1; offsetY = −iDistVer − 1 ;
  case 1: offsetX = uiWidth >> 1; offsetY = −iDistVer −1;
  case 2: offsetX = −iDistHor − 1; offsetY = −iDistVer − 1;
  case 3: offsetX = −iDistHor − 1; offsetY = uiHeigth >> 1;
  case 4: offsetX = −iDistHor − 1; offsetY = uiHeigth + iDistVer − 1;
  }
  }
  }
```

The coordinates (xNb, yNb) of different search positions are obtained according to the coordinate offsets of search positions, where xNb=xTL+offsetX and yNb=yTL+offsetY. The coding block information corresponding to the adjacent position (xNb[idx], yNb[idx]) are stored in the candidate list.

Step b, available candidate blocks in the candidate list are sorted according to the positional distances.

The top-left corner position of the available cuNeibor[idx] in the candidate list is denoted as (xNeiTL, yNeiTL), and then the distance between the current block and the candidate block cuNeibor[idx] is dists[idx]=(abs(xTL−xNeiTL)+abs(yTL−yNeiTL)). The available candidate blocks are sorted in ascending order of the value of dists[idx], when the values of dists[idx] are equal, the available candidate blocks are sorted according to the search order.

Step c, the gradient histograms of the top 5 cuNeibor[idx] after sorting are read, which are denoted as HoGN[nei], where nei=0 . . . 4. If the number of available candidate cuNeibor is less than 5, the HoGN[nei] corresponding to as many available candidate cuNeibor[idx] as possible are taken.

Step d, arithmetic averaging is performed on the obtained gradient histograms HoGN[nei] to calculate a gradient histogram HoGM.

Step e, the gradient histogram HoGM is saved per coding block.

Step f, the intra prediction mode of the current block is obtained based on the gradient histogram HoGM.

In the DIMD prediction scenario, all or part information of the gradient histogram is stored for subsequent operations, and detailed descriptions can take reference to S2.2 below.

In other application scenarios, a directional mode IntraPredModeD can be further obtained according to the information in the gradient histogram. For example, if the HoG has no non-zero amplitude, set IntraPredModeD to PLANAR. Otherwise, set IntraPredModeD to argmaxᵢ(HoG[i]), where i=0, . . . , N, and argmax; (L[i]) returns the index between 0 and N that maximizes L. If there are multiple indexes that maximize L, the index with the smaller value can be returned. Finally, map predModeIntra to IntraPredModeD. It should be understood that this part is not mandatory in the scenario of obtaining the prediction value based on DIMD.

### S2.2 Obtain Prediction Value by DIMD Merge

The implementation of S2.2 can take reference to the description above, which will not be repeated herein.

This example proposes a DIMD Merge technical solution based on a larger search area, which can effectively use the direction of the coding block at the adjacent position to guide the current block and improve the accuracy of generating the prediction value according to the derived intra prediction mode. When the solution is tested on ECM10.0 under the All Intra condition at 48-frame intervals, a −0.10% BD-rate change (i.e., average bitstream change under the same psnr) can be obtained in the Y component.

The method embodiments of the present disclosure are described in detail above with reference to FIG. 1 to FIG. 10, and the device embodiments of the present disclosure will be described in detail below with reference to FIG. 11 to FIG. 14. It should be understood that the description of the method embodiments corresponds to the descriptions of the device embodiments, so the parts not described in detail can take reference to the previous method embodiments.

FIG. 11 is a schematic structural diagram of a decoder provided in an embodiment of the present disclosure. The decoder 1100 in FIG. 11 includes a parsing unit 1110, a first determining unit 1120, a second determining unit 1130, and a third determining unit 1140. The parsing unit 1110 is configured to parse a bitstream to determine first flag information, where the first flag information indicates that the DIMD Merge mode is used for the current block. The first determining unit 1120 is configured to determine multiple search positions around the current block according to the first flag information, where the multiple search positions include a spatial non-adjacent position of the current block. The second determining unit 1130 is configured to determine gradient information to be blended according to the multiple search positions. The third determining unit 1140 is configured to determine a prediction value of the current block according to the gradient information to be blended.

In some implementations, the spatial non-adjacent position is determined based on a predefined position.

In some implementations, the predefined position is determined based on at least one of the following:
a size of the current block;
a predefined horizontal size; or
a predefined vertical size.

In some implementations, the predefined horizontal size and/or the predefined vertical size is determined based on the size of the current block.

In some implementations, the number of the multiple search positions is greater than 13.

In some implementations, the number of the multiple search positions is greater than or equal to 31.

In some implementations, the spatial non-adjacent position satisfies at least one of the following:
an absolute value of a horizontal offset between the spatial non-adjacent position and a top-left corner position of the current block being equal to iDistHor+1; or
an absolute value of a vertical offset between the spatial non-adjacent position and the top-left corner position of the current block being equal to iDistVer+1, where iDistHor is equal to the predefined horizontal size, and iDistVer is equal to the predefined vertical size.

In some implementations, the predefined horizontal size is equal to N times a width of the current block, and/or the predefined vertical size is equal to N times a height of the current block.

In some implementations, the value of Nis less than or equal to 4.

In some implementations, the value of N includes 1, 2, 3, and 4.

In some implementations, the spatial non-adjacent position satisfies: xNb=xTL+offsetX, and yNb=yTL+offset, where offsetX and offsetY satisfy at least one of the following:
offsetX=uiWidth+iDistHor−1, and offsetY=−iDistVer−1;
offsetX=uiWidth>>1, and offsetY=−iDistVer−1;
offsetX=−iDistHor−1, and offsetY=−iDistVer−1;
offsetX=−iDistHor−1, and offsetY=uiHeigth>>1; or offsetX=−iDistHor−1, and offsetY=uiHeigth+iDistVer−1, where xNb represents a horizontal coordinate of the spatial non-adjacent position, yNb represents a vertical coordinate of the spatial non-adjacent position, xTL represents a horizontal coordinate of the top-left corner position of the current block, yTL represents a vertical coordinate of the top-left corner position of the current block, uiWidth represents the width of the current block, and uiHeigth represents the height of the current block.

In some implementations, when N=1, offsetX and offsetY satisfy at least one of the following:

$$offsetX = uiWidth + iDistHor - 1 , and offsetY = - iDistVer - 1 ;$$

$$offsetX = - iDistHor - 1 , and offsetY = - iDistVer - 1 ; or$$

$$offsetX = - iDistHor - 1 , and offsetY = uiHeight + iDistVer - 1.$$

In some implementations, the spatial non-adjacent position satisfies at least one of the following:
being at the top-right of the current block;
being above the current block;
being at the top-left of the current block;
being to the left of the current block; or
being at the bottom-left of the current block . . .

In some implementations, the gradient information to be blended is gradient information corresponding to K candidate blocks, the K candidate blocks are determined based on the multiple search positions, and K is a positive integer greater than 3.

In some implementations, the value of K is greater than or equal to 5.

In some implementations, the gradient information to be blended is determined based on a candidate-block set determined according to the multiple search positions, and the candidate-block set does not include a duplicate candidate block.

In some implementations, the prediction value is determined based on target gradient information, and the target gradient information is determined by performing arithmetic averaging or weighted averaging on the gradient information to be blended.

In some implementations, the gradient information to be blended is gradient information corresponding to at least one candidate block, and a weight of the gradient information corresponding to the at least one candidate block is determined based on at least one of the following:
a distance between the at least one candidate block and the current block; or
the number of target pixels corresponding to the at least one candidate block, where the target pixels are pixels required for determining gradient information in a DIMD mode.

In some implementations, the number of target pixels corresponding to the at least one candidate block is used for determining an initial weight of the gradient information corresponding to the at least one candidate block, and the distance between the at least one candidate block and the current block is used for adjusting the initial weight to determine a target weight of the gradient information corresponding to the at least one candidate block.

In some implementations, gradient information corresponding to each candidate block among the at least one candidate block includes an amplitude corresponding to an IPM, and the amplitude corresponding to the IPM is an amplitude normalized based on the size of each candidate block.

In some implementations, the value range of Nis determined based on the size of the current block.

In some implementations, if the size of the current block is a first size, the value range of Nis a first value range, and if the size of the current block is a second size, the value range of N is a second value range, where the first size is smaller than the second size, and the first value range is narrower than the second value range.

In some implementations, the multiple search positions further include the spatial adjacent position of the current block. If the size of the current block is smaller than a preset size, the spatial adjacent position does not include at least one of the following positions:
a first position, corresponding to a 1/4 position of the height of the current block;
a second position, corresponding to a 1/4 position of the width of the current block;
a third position, corresponding to a 3/4 position of the height of the current block;
a fourth position, corresponding to a 3/4 position of the width of the current block;
a fifth position, corresponding to a 1/2 position of the height of the current block; or
a sixth position, corresponding to a 1/2 position of the width of the current block.

In some implementations, a search order for the multiple search positions is determined based on the distances between the multiple search positions and the current block.

In some implementations, the distances between the multiple search positions and the current block are determined based on distances between the multiple search positions and the top-left corner position of the current block.

In some implementations, the search order for the multiple search positions is an ascending order of the distances between the multiple search positions and the current block.

In some implementations, if two search positions among the multiple search positions have a same distance to the current block, searching is first performed on a search position to the left of the current block, and then on a search position above the current block. Alternatively, if two search positions among the plurality of search positions have a same distance to the current block, for the two search positions, searching is first performed on the search position above the current block, and then on the search position to the left of the current block.

In some implementations, the gradient information to be blended is gradient information corresponding to at least one candidate block in the candidate-block set, the candidate-block set includes M candidate blocks, and the order for the M candidate blocks in the candidate-block set is determined based on distances between the M candidate blocks and the current block, where Mis a positive integer greater than or equal to 1.

In some implementations, if two candidate blocks among the M candidate blocks have the same distance to the current block, for the two candidate blocks, an order for a candidate block to the left of the current block is higher than an order for a candidate block above the current block. Alternatively, if two candidate blocks among the M candidate blocks have the same distance to the current block, for the two candidate blocks, the order for the candidate block above the current block is higher than the order of the candidate block to the left of the current block.

In some implementations, the M candidate blocks include a first candidate block, a distance between the first candidate block and the current block is determined based on a difference between a first distance and a second distance, the first distance represents a horizontal distance between a top-left corner position of the first candidate block and the top-left corner position of the current block, and the second distance represents a vertical distance between the top-left corner position of the first candidate block and the top-left corner position of the current block.

In some implementations, the distance between the first candidate block and the current block satisfies: (abs(xTL−xNeiTL)+abs(yTL−yNeiTL)+abs(abs(xTL−xNeiTL)−abs(yTL−yNeiTL))), where xTL represents the horizontal coordinate of the top-left corner position of the current block, yTL represents the vertical coordinate of the top-left corner position of the current block, xNeiTL represents a horizontal coordinate of the top-left corner position of the first candidate block, yNeiTL represents a vertical coordinate of the top-left corner position of the first candidate block, and abs represents an absolute value operation.

In some implementations, the gradient information is stored per coding block, or the gradient information is stored per picture block with a fixed size in a current frame.

In some implementations, the size of the picture block is determined based on the resolution of the current frame.

In some implementations, the gradient information to be blended is gradient information corresponding to at least one candidate block in the candidate-block set. Whether two candidate blocks in the candidate-block set are duplicate is determined based on at least one of the following:
whether the two candidate blocks correspond to the same coding block; or
whether a difference between gradient information corresponding to the two candidate blocks satisfies a preset condition.

In some implementations, the two candidate blocks include a first candidate block and a second candidate block. The first candidate block corresponds to a first gradient histogram, and the second candidate block corresponds to a second gradient histogram. The SIPMs with the highest amplitudes in the first gradient histogram form a first set, and the SIPMs with the highest amplitudes in the second gradient histogram form a second set. The difference between the gradient information corresponding to the two candidate blocks is determined based on a difference between the first set and the second set, where Sis a positive integer greater than or equal to 1.

In some implementations, the difference between the first set and the second set is determined based on at least one of the following:
the number of identical IPMs included in the first set and the second set; or
the difference between the first IPM in the first set and the second IPM in the second set, where the first set does not include the second IPM and the second set does not include the first IPM.

In some implementations, if the number of identical IPMs included in the first set and the second set is greater than or equal to a first threshold, the two candidate blocks are duplicate. Additionally/Alternatively, if the difference between the first IPM and the second IPM is less than or equal to a second threshold, the two candidate blocks are duplicate.

Additionally/Alternatively, if a ratio of an intersection of the first set and the second set to a union of the first set and the second set is greater than or equal to a third threshold, the two candidate blocks are duplicate.

In some implementations, at least one of the following is determined based on the size of the current block:
the number of candidate blocks in the candidate-block set, where the candidate-block set is determined based on the multiple search positions;
the number of gradient information to be blended; or
the number of IPMs used for determining the prediction value.

In some implementations, the spatial non-adjacent position is determined based on a pre-established first mapping relationship, where the first mapping relationship is a mapping relationship between indexes of spatial non-adjacent positions and coordinates of the spatial non-adjacent positions. Alternatively, the spatial non-adjacent position is determined based on a pre-established first mapping relationship and a pre-established second mapping relationship. The first mapping relationship is a mapping relationship between the indexes of the spatial non-adjacent positions and search distances, and the second mapping relationship is a mapping relationship between the indexes of the spatial non-adjacent positions and search directions.

In some implementations, the search distance is a distance between the spatial non-adjacent position and the top-left corner position of the current block. Additionally/Alternatively, the search direction is the direction of the spatial non-adjacent position relative to the current block.

In some implementations, the gradient information is a set of IPMs and amplitudes corresponding to the set of IPMs, or the gradient histogram information.

It will be understood that in the embodiments of the disclosure, the “unit” may be part of the circuitry, part of the processor, part of the program or software, etc., and of course may also be a module, or may be non-modular. In addition, various components described in the embodiments may be integrated into one processing unit or may be present as a number of physically separated units, or two or more units may be integrated into one. The integrated units may be implemented either in the form of hardware or in the form of software function modules.

If the integrated unit is implemented as a software function module and not sold or used as a stand-alone product, the integrated unit may be stored in a computer-readable storage medium. Based on such understanding, the technical solutions of the embodiments in essential, or a part that contributes to the prior art, or all or part of the technical solutions, may be embodied in the form of a software product. The computer software product is stored in a storage medium and includes a number of instructions to enable a computer device (which may be a personal computer, a server, or a network device, etc.) or processor to perform all or part of the operations of the method described in the embodiments. The aforementioned storage medium includes a USB stick, a removable hard disk, a read only memory (ROM), a random access memory (RAM), a diskette or a CD-ROM, and other media that may store program codes.

Therefore, a computer-readable storage medium is provided in the embodiments of the disclosure. The computer-readable storage medium is applied to a decoder 1100. The computer-readable storage medium stores a computer program, which, when executed by a processor, implements the decoding method described in any one of the foregoing embodiments.

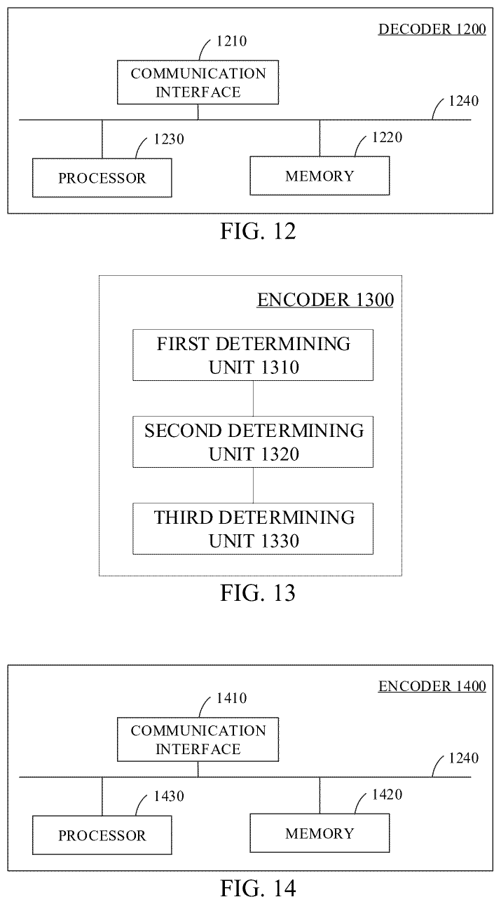

Based on the composition of the aforementioned decoder 1100 and the computer-readable storage medium, FIG. 12 illustrates a specific hardware structural diagram of the decoder 1100 provided in the embodiments of the present disclosure. As illustrated in FIG. 12, the decoder 1200 may include a communication interface 1210, a memory 1220, and a processor 1230. The various components are coupled together via a bus system 1240. It can be understood that the bus system 1240 is configured to enable connection communication between these components. The bus system 1240 includes a power bus, a control bus, and a status signal bus in addition to a data bus. For the sake of clarity, however, the various buses are labelled as the bus system 1240 in FIG. 12. The communication interface 1210 is configured to receive and transmit signals during information transmission with other external network elements. The memory 1220 is configured to store a computer program. The processor 1230 is configured to, when executing the computer program, perform the following steps. The processor 1230 is configured to parse a bitstream to determine first flag information, where the first flag information indicates that a DIMD Merge mode is used for a current block. The processor 1230 is further configured to determine multiple search positions around the current block according to the first flag information, where the multiple search positions include a spatial non-adjacent position of the current block. The processor 1230 is further configured to determine gradient information to be blended according to the multiple search positions. The processor 1230 is further configured to determine a prediction value of the current block according to the gradient information to be blended.

It will be appreciated that the memory 1220 in embodiments of the disclosure may be a transitory memory or non-transitory memory, or may include both transitory and non-transitory memory. In particular, the non-transitory memory may be a read-only memory (ROM), a programmable ROM (PROM), an erasable PROM (EPROM), an electrically EPROM (EEPROM), or a flash memory. The transitory memory may be a random access memory (RAM), which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct rambus RAM (DRRAM). The memory 1220 of the system and method described in this disclosure is intended to include, but is not limited to, these and any other suitable types of memory.

The processor 1230 may be an integrated circuit chip with signal processing capabilities. In implementation, the operations in the above method may be accomplished by integrated logic circuitry in the hardware of the processor 1230 or by instructions in the form of software. The processor 1230 described above may be a general purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 1220 and the processor 1230 reads the information in the memory 1220 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the processor 1230 is further configured to perform the decoding method described in any of the above embodiments when executing the computer program.

FIG. 13 is a schematic structural diagram of an encoder provided in an embodiment of the present disclosure. The encoder 1300 in FIG. 13 includes a first determining unit 1310, a second determining unit 1320, and a third determining unit 1330. The first determining unit 1310 is configured to determine multiple search positions around the current block according to the first flag information, where the multiple search positions include a spatial non-adjacent position of the current block. The second determining unit 1320 is configured to determine gradient information to be blended according to the multiple search positions. The third determining unit 1330 is configured to determine a prediction value of the current block according to the gradient information to be blended.

In some implementations, the spatial non-adjacent position is determined based on a size of the current block.

In some implementations, the number of the multiple search positions is greater than 13.

In some implementations, the number of the multiple search positions is greater than or equal to 31.

In some implementations, the spatial non-adjacent position satisfies at least one of the following:
an absolute value of a horizontal offset between the spatial non-adjacent position and a top-left corner position of the current block being equal to iDistHor+1; or
an absolute value of a vertical offset between the spatial non-adjacent position and the top-left corner position of the current block being equal to iDistVer+1, where iDistHor is equal to N times a width of the current block, iDistVer is equal to N times a height of the current block, and N is a positive integer greater than or equal to 1.

In some implementations, the value of Nis less than or equal to 4.

In some implementations, the value of N includes 1, 2, 3, and 4.

In some implementations, the spatial non-adjacent position satisfies: xNb=xTL+offsetX, and yNb=yTL+offset, where offsetX and offsetY satisfy at least one of the following:
offsetX=uiWidth+iDistHor−1, and offsetY=−iDistVer−1;
offsetX=uiWidth>>1, and offsetY=−iDistVer−1;
offsetX=−iDistHor−1, and offsetY=−iDistVer−1;
offsetX=−iDistHor−1, and offsetY=uiHeigth>>1; or
offsetX=−iDistHor−1, and offsetY=uiHeigth+iDistVer−1, where xNb represents a horizontal coordinate of the spatial non-adjacent position, yNb represents a vertical coordinate of the spatial non-adjacent position, xTL represents a horizontal coordinate of the top-left corner position of the current block, yTL represents a vertical coordinate of the top-left corner position of the current block, uiWidth represents the width of the current block, and uiHeigth represents the height of the current block.

In some implementations, when N=1, offsetX and offsetY satisfy at least one of the following:

$$offsetX = uiWidth + iDistHor - 1 , and offsetY = - iDistVer - 1 ;$$

$$offsetX = - iDistHor - 1 , and offsetY = - iDistVer - 1 ; or$$

$$offsetX = - iDistHor - 1 , and offsetY = uiHeight + iDistVer - 1.$$

In some implementations, the spatial non-adjacent position satisfies at least one of the following:
being at the top-right of the current block;
being above the current block;
being at the top-left of the current block;
being to the left of the current block; or being at the bottom-left of the current block . . .

In some implementations, the gradient information to be blended is gradient information corresponding to K candidate blocks, the K candidate blocks are determined based on the multiple search positions, and K is a positive integer greater than 3.

In some implementations, the value of K is greater than or equal to 5.

In some implementations, the gradient information to be blended is determined based on a candidate-block set, and the candidate-block set does not include a duplicate candidate block.

In some implementations, the prediction value is determined based on target gradient information, and the target gradient information is determined by performing arithmetic averaging or weighted averaging on the gradient information to be blended.

In some implementations, the gradient information to be blended is gradient information corresponding to at least one candidate block, and a weight of the gradient information corresponding to the at least one candidate block is determined based on at least one of the following:
a distance between the at least one candidate block and the current block; or
the number of target pixels corresponding to the at least one candidate block, where the target pixels are pixels required for determining gradient information in a DIMD mode.

In some implementations, the number of target pixels corresponding to the at least one candidate block is used for determining an initial weight of the gradient information corresponding to the at least one candidate block, and the distance between the at least one candidate block and the current block is used for adjusting the initial weight to determine a target weight of the gradient information corresponding to the at least one candidate block.

In some implementations, gradient information corresponding to each candidate block among the at least one candidate block includes an amplitude corresponding to an IPM, and the amplitude corresponding to the IPM is an amplitude normalized based on the size of each candidate block.

In some implementations, the value range of Nis determined based on the size of the current block.

In some implementations, if the size of the current block is a first size, the value range of N is a first value range, and if the size of the current block is a second size, the value range of Nis a second value range, where the first size is smaller than the second size, and the first value range is narrower than the second value range.

In some implementations, the multiple search positions further include the spatial adjacent position of the current block. If the size of the current block is smaller than a preset size, the spatial adjacent position does not include at least one of the following positions:
a first position, corresponding to a 1/4 position of the height of the current block;
a second position, corresponding to a 1/4 position of the width of the current block;
a third position, corresponding to a 3/4 position of the height of the current block;
a fourth position, corresponding to a 3/4 position of the width of the current block;
a fifth position, corresponding to a 1/2 position of the height of the current block; or
a sixth position, corresponding to a 1/2 position of the width of the current block.

In some implementations, a search order for the multiple search positions is determined based on the distances between the multiple search positions and the current block.

In some implementations, the distances between the multiple search positions and the current block are determined based on distances between the multiple search positions and the top-left corner position of the current block.

In some implementations, the search order for the multiple search positions is an ascending order of the distances between the multiple search positions and the current block.

In some implementations, if two search positions among the multiple search positions have a same distance to the current block, searching is first performed on a search position to the left of the current block, and then on a search position above the current block. Alternatively, if two search positions among the plurality of search positions have a same distance to the current block, for the two search positions, searching is first performed on the search position above the current block, and then on the search position to the left of the current block.

In some implementations, the gradient information to be blended is gradient information corresponding to at least one candidate block in the candidate-block set, the candidate-block set includes M candidate blocks, and the order for the M candidate blocks in the candidate-block set is determined based on distances between the M candidate blocks and the current block, where Mis a positive integer greater than or equal to 1.

In some implementations, if two candidate blocks among the M candidate blocks have the same distance to the current block, for the two candidate blocks, an order for a candidate block to the left of the current block is higher than an order for a candidate block above the current block. Alternatively, if two candidate blocks among the M candidate blocks have the same distance to the current block, for the two candidate blocks, the order for the candidate block above the current block is higher than the order of the candidate block to the left of the current block.

In some implementations, the M candidate blocks include a first candidate block, a distance between the first candidate block and the current block is determined based on a difference between a first distance and a second distance, the first distance represents a horizontal distance between a top-left corner position of the first candidate block and the top-left corner position of the current block, and the second distance represents a vertical distance between the top-left corner position of the first candidate block and the top-left corner position of the current block.

In some implementations, the distance between the first candidate block and the current block satisfies: (abs(xTL−xNeiTL)+abs(yTL−yNeiTL)+abs(abs(xTL−xNeiTL)−abs(yTL−yNeiTL))), where xTL represents the horizontal coordinate of the top-left corner position of the current block, yTL represents the vertical coordinate of the top-left corner position of the current block, xNeiTL represents a horizontal coordinate of the top-left corner position of the first candidate block, yNeiTL represents a vertical coordinate of the top-left corner position of the first candidate block, and abs represents an absolute value operation.

In some implementations, the gradient information is stored per coding block, or the gradient information is stored per picture block with a fixed size in a current frame.

In some implementations, the size of the picture block is determined based on the resolution of the current frame.

In some implementations, the gradient information to be blended is gradient information corresponding to at least one candidate block in the candidate-block set. Whether two candidate blocks in the candidate-block set are duplicate is determined based on at least one of the following:
whether the two candidate blocks correspond to the same coding block; or
whether a difference between gradient information corresponding to the two candidate blocks satisfies a preset condition.

In some implementations, the two candidate blocks include a first candidate block and a second candidate block. The first candidate block corresponds to a first gradient histogram, and the second candidate block corresponds to a second gradient histogram. The SIPMs with the highest amplitudes in the first gradient histogram form a first set, and the SIPMs with the highest amplitudes in the second gradient histogram form a second set. The difference between the gradient information corresponding to the two candidate blocks is determined based on a difference between the first set and the second set, where Sis a positive integer greater than or equal to 1.

In some implementations, the difference between the first set and the second set is determined based on at least one of the following:
the number of identical IPMs included in the first set and the second set; or
the difference between the first IPM in the first set and the second IPM in the second set, where the first set does not include the second IPM and the second set does not include the first IPM.

In some implementations, if the number of identical IPMs included in the first set and the second set is greater than or equal to a first threshold, the two candidate blocks are duplicate. Additionally/Alternatively, if the difference between the first IPM and the second IPM is less than or equal to a second threshold, the two candidate blocks are duplicate. Additionally/Alternatively, if a ratio of an intersection of the first set and the second set to a union of the first set and the second set is greater than or equal to a third threshold, the two candidate blocks are duplicate.

In some implementations, at least one of the following is determined based on the size of the current block:
the number of candidate blocks in the candidate-block set, where the candidate-block set is determined based on the multiple search positions;
the number of gradient information to be blended; or
the number of IPMs used for determining the prediction value.

In some implementations, the spatial non-adjacent position is determined based on a pre-established first mapping relationship, where the first mapping relationship is a mapping relationship between indexes of spatial non-adjacent positions and coordinates of the spatial non-adjacent positions. Alternatively, the spatial non-adjacent position is determined based on a pre-established first mapping relationship and a pre-established second mapping relationship. The first mapping relationship is a mapping relationship between the indexes of the spatial non-adjacent positions and search distances, and the second mapping relationship is a mapping relationship between the indexes of the spatial non-adjacent positions and search directions.

In some implementations, the search distance is a distance between the spatial non-adjacent position and the top-left corner position of the current block. Additionally/Alternatively, the search direction is the direction of the spatial non-adjacent position relative to the current block.

In some implementations, the gradient information is a set of IPMs and amplitudes corresponding to the set of IPMs, or the gradient histogram information.

It will be understood that in the embodiments of the disclosure, the “unit” may be part of the circuitry, part of the processor, part of the program or software, etc., and of course may also be a module, or may be non-modular. In addition, various components described in the embodiments may be integrated into one processing unit or may be present as a number of physically separated units, or two or more units may be integrated into one. The integrated units may be implemented either in the form of hardware or in the form of software function modules.

If the integrated unit is implemented as a software function module and not sold or used as a stand-alone product, the integrated unit may be stored in a computer-readable storage medium. Based on such understanding, the technical solutions of the embodiments in essential, or a part that contributes to the prior art, or all or part of the technical solutions, may be embodied in the form of a software product. The computer software product is stored in a storage medium and includes a number of instructions to enable a computer device (which may be a personal computer, a server, or a network device, etc.) or processor to perform all or part of the operations of the method described in the embodiments. The aforementioned storage medium includes a USB stick, a removable hard disk, a ROM, a RAM, a diskette or a CD-ROM, and other media that may store program codes.

Therefore, a computer-readable storage medium is provided in the embodiments of the disclosure. The computer-readable storage medium is applied to a encoder 1300. The computer-readable storage medium stores a computer program, which, when executed by a processor, implements the encoding method described in any one of the foregoing embodiments.

Based on the composition of the aforementioned encoder 1200 and the computer-readable storage medium, FIG. 14 illustrates a specific hardware structural diagram of the encoder 1400 provided in the embodiments of the present disclosure. As illustrated in FIG. 14, the encoder 1400 may include a communication interface 1410, a memory 1420, and a processor 1430. The various components are coupled together via a bus system 1440. It can be understood that the bus system 1440 is configured to enable connection communication between these components. The bus system 1440 includes a power bus, a control bus, and a status signal bus in addition to a data bus. For the sake of clarity, however, the various buses are labelled as the bus system 1440 in FIG. 14. The communication interface 1410 is configured to receive and transmit signals during information transmission with other external network elements. The memory 1420 is configured to store a computer program. The processor 1430 is configured to, when executing the computer program, perform the following steps. The processor 1430 is further configured to determine multiple search positions around the current block, where the multiple search positions include a spatial non-adjacent position of the current block. The processor 1430 is further configured to determine gradient information to be blended according to the multiple search positions. The processor 1430 is further configured to determine a prediction value of the current block according to the gradient information to be blended.

It will be appreciated that the memory 1420 in embodiments of the disclosure may be a transitory memory or non-transitory memory, or may include both transitory and non-transitory memory. In particular, the non-transitory memory may be a read-only memory (ROM), a programmable ROM (PROM), an erasable PROM (EPROM), an electrically EPROM (EEPROM), or a flash memory. The transitory memory may be a random access memory (RAM), which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct rambus RAM (DRRAM). The memory 1420 of the system and method described in this disclosure is intended to include, but is not limited to, these and any other suitable types of memory.

The processor 1430 may be an integrated circuit chip with signal processing capabilities. In implementation, the operations in the above method may be accomplished by integrated logic circuitry in the hardware of the processor 1430 or by instructions in the form of software. The processor 1430 described above may be a general purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the memory 1420 and the processor 1430 reads the information in the memory 1420 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the processor 1430 is further configured to perform the encoding method described in any of the above embodiments when executing the computer program.

Embodiments of the present disclosure further provide a computer-readable storage medium. The computer-readable storage medium is a non-transitory computer-readable storage medium storing a bitstream, where the bitstream can be generated by using an encoding method of an encoder, or decoded by using a decoding method of a decoder. The decoding method may be the decoding method described in any one of the foregoing embodiments, and the encoding method may be the encoding method described in any one of the foregoing embodiments.

It may be noted that in the disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or device. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

What is claimed is:

1. A decoding method, applied to a decoder and comprising:
parsing a bitstream to determine first flag information;
determining a plurality of search positions around a current block according to the first flag information, wherein the plurality of search positions comprise a spatial non-adjacent position of the current block;
determining gradient information to be blended according to the plurality of search positions; and
determining a prediction value of the current block according to the gradient information to be blended.

2. The method of claim 1, wherein:
a number of the plurality of search positions is greater than 13; or
the a number of the plurality of search positions is greater than or equal to 31.

3. The method of claim 1, wherein the spatial non-adjacent position satisfies at least one of:
an absolute value of a horizontal offset between the spatial non-adjacent position and a top-left corner position of the current block being equal to iDistHor+1; or
an absolute value of a vertical offset between the spatial non-adjacent position and the top-left corner position of the current block being equal to iDistVer+1,
wherein iDistHor is equal to a predefined horizontal size, and iDistVer is equal to a predefined vertical size.

4. The method of claim 3, wherein:
the predefined horizontal size is equal to N times a width of the current block; and/or
the predefined vertical size is equal to N times a height of the current block.

5. The method of claim 1, wherein the spatial non-adjacent position satisfies at least one of:
being at a top-right of the current block;
being above the current block;
being at a top-left of the current block;
being to a left of the current block; or
being at a bottom-left of the current block.

6. The method of claim 1, wherein the gradient information to be blended is gradient information corresponding to K candidate blocks, the K candidate blocks are determined based on the plurality of search positions, and K is a positive integer greater than 3.

7. The method of claim 6, wherein a value of K is greater than or equal to 5.

8. The method of claim 1, wherein the gradient information to be blended is determined based on a candidate-block set determined according to the plurality of search positions, and the candidate-block set does not comprise a duplicate candidate block.

9. The method of claim 1, wherein the prediction value is determined based on target gradient information, and the target gradient information is determined by performing arithmetic averaging or weighted averaging on the gradient information to be blended.

10. The method of claim 9, wherein the gradient information to be blended is gradient information corresponding to at least one candidate block, and a weight of the gradient information corresponding to the at least one candidate block is determined based on at least one of:
a distance between the at least one candidate block and the current block; or
a number of target pixels corresponding to the at least one candidate block, wherein the target pixels are pixels required for determining gradient information in a DIMD mode.

11. The method of claim 10, wherein the number of target pixels corresponding to the at least one candidate block is used for determining an initial weight of the gradient information corresponding to the at least one candidate block, and the distance between the at least one candidate block and the current block is used for adjusting the initial weight to determine a target weight of the gradient information corresponding to the at least one candidate block.

12. The method of claim 4, wherein a value range of Nis determined based on a size of the current block.

13. The method of claim 12, wherein:
if the size of the current block is a first size, the value range of Nis a first value range; and
if the size of the current block is a second size, the value range of Nis a second value range, wherein
the first size is smaller than the second size, and the first value range is narrower than the second value range.

14. The method of claim 1, wherein the gradient information to be blended is gradient information corresponding to at least one candidate block in a candidate-block set, the candidate-block set comprises M candidate blocks, an order of the M candidate blocks in the candidate-block set is determined based on distances between the M candidate blocks and the current block, and Mis a positive integer greater than or equal to 1.

15. The method of claim 14, wherein:
if two candidate blocks among the M candidate blocks have a same distance to the current block, for the two candidate blocks, an order of a candidate block to a left of the current block is higher than an order of a candidate block above the current block; or
if two candidate blocks among the M candidate blocks have a same distance to the current block, for the two candidate blocks, the order of the candidate block above the current block is higher than the order of the candidate block to the left of the current block.

16. The method of claim 1, wherein the gradient information is stored per coding block, or the gradient information is stored per picture block with a fixed size in a current frame.

17. The method of claim 8, wherein whether two candidate blocks in the candidate-block set are duplicate is determined based on at least one of:
whether the two candidate blocks correspond to a same coding block; or
whether a difference between gradient information corresponding to the two candidate blocks satisfies a preset condition.

18. The method of claim 1, wherein at least one of the following is determined based on a size of the current block:
a number of candidate blocks in a candidate-block set, wherein the candidate-block set is determined based on the plurality of search positions;
a number of the gradient information to be blended; or
a number of IPMs used for determine the prediction value.

19. An encoding method, applied to an encoder and comprising:
determining a plurality of search positions around a current block, wherein the plurality of search positions comprise a spatial non-adjacent position of the current block;
determining gradient information to be blended according to the plurality of search positions; and
determining a prediction value of the current block according to the gradient information to be blended.

20. A non-transitory computer-readable storage medium storing a bitstream and a computer program, wherein when executed by a processor, the computer program causes the processor to generate the bitstream according to an encoding method, the encoding method comprising:
determining a plurality of search positions around a current block, wherein the plurality of search positions comprise a spatial non-adjacent position of the current block;
determining gradient information to be blended according to the plurality of search positions; and
determining a prediction value of the current block according to the gradient information to be blended.
